(19) United States
(12) Patent Application Publication
(10) Pub. No.: US 2024/0322894 A1
(43) Pub. Date: Sep. 26, 2024

(54) BEAM SWITCH FOR MULTIPLE TRANSMISSION AND RECEPTION POINTS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tianyang BAI, Mountain View, CA (US); Wooseok NAM, San Diego, CA (US); Tao LUO, San Diego, CA (US); Xiaoxia ZHANG, San Diego, CA (US); Junyi LI, Fairless Hills, PA (US)

(21) Appl. No.: 18/576,032

(22) PCT Filed: Aug. 24, 2021
(86) PCT No.: PCT/CN2021/114302

§ 371 Date: Jan. 2, 2024

(51) Int. Cl. H04B 7/08; H04B 7/06

(52) U.S. Cl. CPC H04B 7/088; H04B 7/0626; H04B 7/06968

(57) ABSTRACT

An apparatus is provided that may be configured to transmit, to a base station having multiple TRPs, a CSI report based on a set of reference signals, the set of reference signals including a first reference signal associated with a first beam direction and a second reference signal associated with a second beam direction. The apparatus may further be configured to switch, for one or more channels, to use the first beam direction with a first TRP of the multiple TRPs before an indication to switch beams is received from the base station.

### TECHNICAL FIELD

The present disclosure relates generally to communication systems, and more particularly, to implicitly switching beams for communication using multiple transmission and reception points (m-TRP) or over an m-TRP architecture.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects of wireless communication, e.g., 5G NR, multiple transmission configuration indicator (TCI) states may be configured at a base station and a user equipment (UE). Each TCI state may be associated with a reference signal (e.g., an SSB reference signal or a channel state information reference signal (CSI-RS)). The multiple TCI states may be used to indicate channel characteristics including a spatial parameter (e.g., a beam direction). A UE may measure multiple reference signals and transmit a report (e.g., a CSI report) regarding the multiple measured reference signals related to one or multiple TRPs at a base station. Based on the CSI report, a base station may transmit an indication (e.g., for beam switching) of a transmission beam (e.g., for at least one uplink channel) or a reception beam (e.g., for at least one downlink channel). In some aspects, the base station may transmit, based on the CSI report, an indication of a set of activated TCI states for beam switching (e.g., candidate TCI states that may be indicated in downlink control information (DCI)) via a medium access control (MAC) control element (MAC-CE). In some aspects, latency may be reduced, and communication may be improved through a beam switch that is performed in response to a CSI report from the UE. The beam switch may be performed without DCI indicating the beam switch and/or without a MAC-CE from the base station activating a new beam. In some aspects, the beam switch may be referred to as an “implicit” beam switch because the UE and the base station may change to communication on a new beam based on the CSI report without additional signaling for the beam switch. In some aspects, the base station may include multiple TRPs (m-TRP). The UE may communicate with the base station via the m-TRPs. Aspects presented herein provide for implicit beam switching for a m-TRP architecture and/or implicit updating for a set of activated TCI states for an m-TRP architecture that may provide the benefit of reduced signaling (e.g., no indication transmitted in DCI or a MAC-CE) while enabling the UE and the base station to understand the TRP and channel for which the beam switch is to be performed. Such implicit beam switching without a DCI indication or implicit updating for a set of activated TCI states without a MAC-CE signaling may reduce the signaling overhead and the latency for communication on an improved beam.

In an aspect of the disclosure, a method, a computer-readable medium, and an apparatus are provided. The apparatus may be a device at a user equipment (UE). The device may be a processor and/or modem at a UE or the UE itself. The UE may be configured to transmit, to a base station having multiple TRPs, a CSI report based on a set of reference signals, the set of reference signals including a first reference signal associated with a first beam direction and a second reference signal associated with a second beam direction. The UE may further be configured to switch, for one or more channels, to use the first beam direction with a first TRP of the multiple TRPs based on the set of reference signals before receiving any transmission corresponding to the first beam direction from the base station.

In an aspect of the disclosure, the apparatus may be a device at a base station. The device may be a processor and/or modem at a base station or the base station itself. The base station may be configured to receive, from a UE, a CSI report based on a set of reference signals, the set of reference signals including a first reference signal associated with a first beam direction and a second reference signal associated with a second beam direction. The base station may further be configured to switch, for one or more channels, to use the first beam direction with a first TRP of the multiple TRPs before transmitting an indication to switch beams to the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a call flow diagram illustrating an implicit beam switch for a UE communicating with a base station.

FIG. 4B and FIG. 4C illustrate example aspects of multiple TRP communication.

FIG. 5 is a call flow diagram illustrating an implicit update to activated TCI states for beam switching for a UE communicating with a base station.

FIG. 6 is a diagram summarizing the relation between different types of CSI reports that may be transmitted by a UE and types of DL channels that may be associated with a reference signal included in a CSI report.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

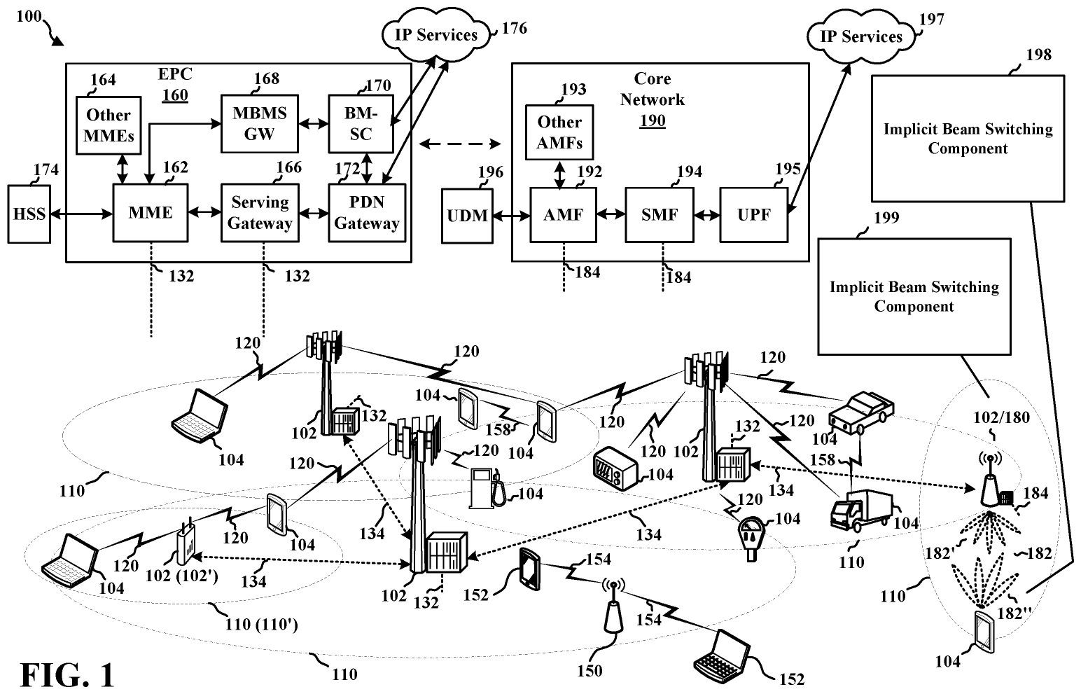

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an implicit beam switching component 198 configured to transmit, to a base station having multiple TRPs, a CSI report based on a set of reference signals, the set of reference signals including a first reference signal associated with a first beam direction and a second reference signal associated with a second beam direction. The implicit beam switching component 198 may further be configured to switch, for one or more channels, to use the first beam direction with a first TRP of the multiple TRPs based on the set of reference signals before receiving any transmission corresponding to the first beam direction from the base station. In certain aspects, the base station 180 may include an implicit beam switching component 199 configured to receive, from a UE, a CSI report based on a set of reference signals, the set of reference signals including a first reference signal associated with a first beam direction and a second reference signal associated with a second beam direction. The implicit beam switching component 199 may further be configured to switch, for one or more channels, to use the first beam direction with a first TRP of the multiple TRPs before transmitting an indication to switch beams to the UE. Although the following description may be focused on 5G NR, the concepts described herein may be applicable to other similar areas, such as LTE, LTE-A, CDMA, GSM, and other wireless technologies.

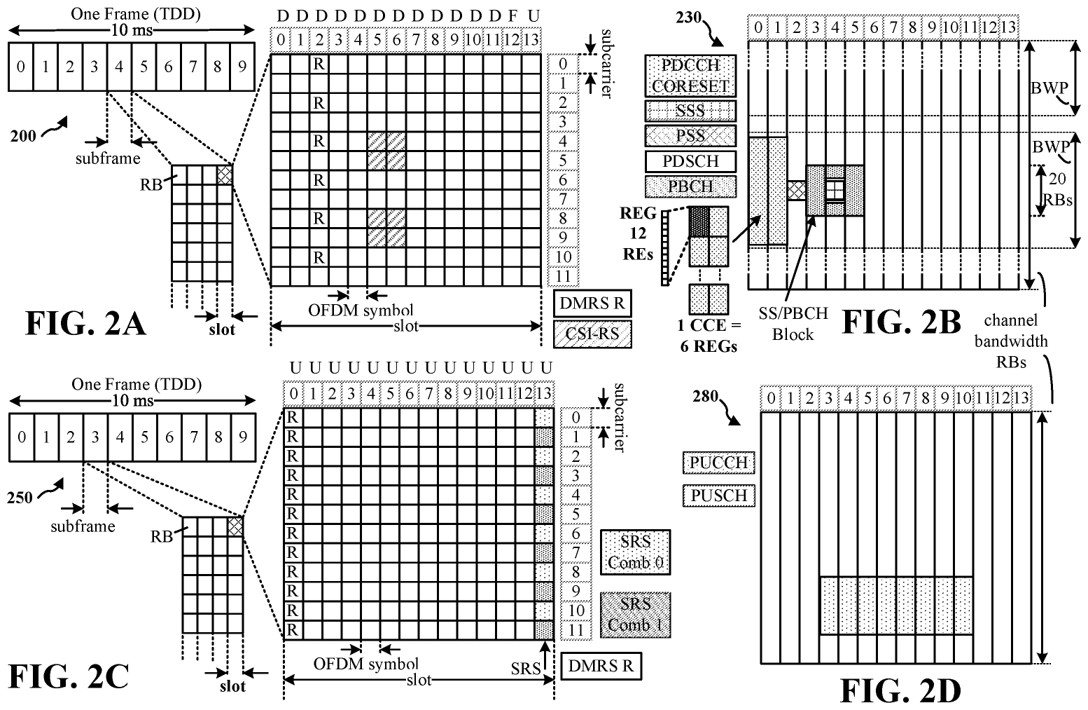

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2″ *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

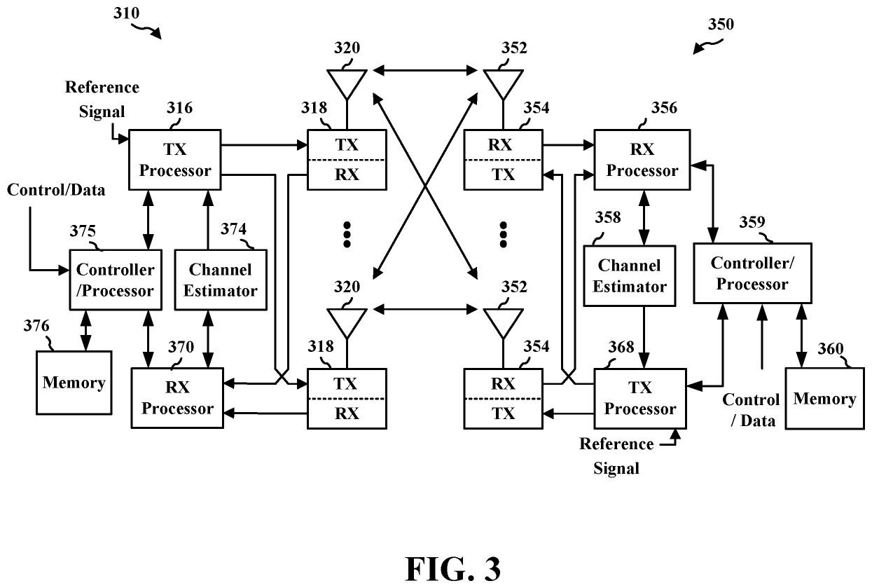

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

In some aspects of wireless communication, e.g., 5G NR, multiple transmission configuration indicator (TCI) states may be configured at a base station and a user equipment (UE). Each TCI state may be associated with a reference signal (e.g., an SSB reference signal or a channel state information reference signal (CSI-RS)). The multiple TCI states may be used to indicate channel characteristics including a spatial parameter (e.g., a beam direction). A UE may measure multiple reference signals and transmit a report (e.g., a CSI report) regarding the multiple measured reference signals. Based on the CSI report, a base station may transmit an indication (e.g., for beam switching) of a transmission beam (e.g., for at least one uplink channel) or a reception beam (e.g., for at least one downlink channel). In some aspects, the base station may transmit, based on the CSI report, an indication of a set of activated TCI states for beam switching (e.g., candidate TCI states that may be indicated in downlink control information (DCI)) via a medium access control (MAC) control element (MAC-CE). A method and apparatus for implicit beam switching initiated by a UE and/or implicit updating for a set of activated TCI states initiated by a UE may provide the benefit of reduced signaling (e.g., no indication transmitted in DCI or a MAC-CE). Specifically, implicit beam switching without a DCI indication and implicit updating for a set of activated TCI states without a MAC-CE signaling may provide the benefit of reducing the signaling overhead.

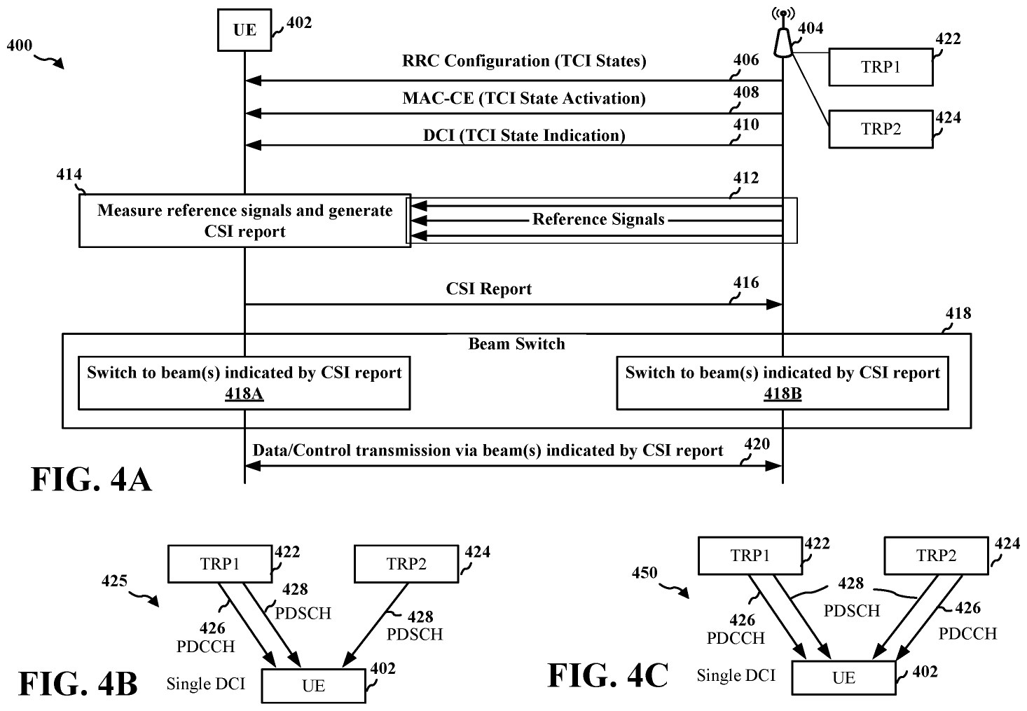

FIG. 4A is a call flow diagram 400 illustrating an implicit beam switch for a UE 402 communicating with a base station 404. In some aspects, the UE 402 and base station 404 may communicate via multiple transmission reception points (TRPs) at the base station 404 (and/or at the UE 402). FIGS. 4B and 4C are examples 425 and 450 of mTRP systems.

The example 425 of FIG. 4B includes a UE 402, a TRP1 422, and a TRP2 424. The TRP1 422 may transmit a PDCCH 426 to the UE 402 as well as a PDSCH 428. The TRP2 424 may transmit a PDSCH 428 to the UE 402. The example in FIG. 4B may be referred to as a single DCI (sDCI) configuration, in which one TRP transmits control signaling to the UE for use in receiving PDSCH from both TRPs. The example 450 of FIG. 4C includes the UE 402, the TRP1 422, and the TRP2 424, but the system of FIG. 4B is a multi-DCI (mDCI) based mTRP transmission system, comprising a joint HARQ or a separate HARQ.

The example 450 in FIG. 4C includes each TRP transmitting both control and data, e.g., PDCCH 426 and PDSCH 428 to the UE 402. The example 425 of FIG. 4B shows a single DCI based mTRP transmission, where the same MCS is used, and each PDSCH 428 may correspond to a set of layers. An advantage of mTRP systems is that such systems may increase the overall transmission power at multiple transmission points, as well as increasing the overall rank of the transmission, which may allow mTRP systems to offer reliability against blocking, for example.

The communication flow in diagram 400 of FIG. 4A illustrates that a base station 404 may transmit, and a UE 402 may receive, an RRC configuration 406 including TCI state information. The base station 404 may subsequently transmit, and the UE 402 may receive, a MAC-CE 408 indicating a set of activated TCI states (e.g., a set of eight TCI states). The activated TCI states may be associated with a set of codepoints (e.g., associated with values from zero to seven) used to indicate an activated TCI state in DCI. The base station 404 may also transmit, and the UE 402 may receive, DCI 410 including an indication of a TCI state (e.g., a quasi-co-located (QCL) beam having a QCL type D relationship to a reference signal that indicates a beam direction) in the activated states for at least one of an uplink (UL) transmission from the UE or a downlink (DL) reception from the base station. The base station 404 may then transmit, and the UE 402 may receive, a set of reference signals 412.

The UE may measure 414 the received set of reference signals 412 to identify a preferred beam for future communication and may generate a CSI report. The UE 402 may then transmit, and the base station 404 may receive, a CSI report 416. As part of the implicit beam switch, the UE and base station may switch beams to a beam reported as having a better quality in the CSI report 416, e.g., without an explicit beam indication from the base station 404.

The CSI report may be applicable for m-TRP operation configured with a unified TCI. In a unified TCI framework, different types of common TCI states may be indicated. The unified TCI state may be applicable to specific channels. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

For m-TRP communication, e.g., via the TRP 422 and TRP 424, the CSI report 416, may be based on, e.g., report, a set of reference signals (e.g., reference signals in the received set of reference signals 412). The set of reference signals reported by the CSI report may include, e.g., a first reference signal associated with a first beam direction and a second reference signal associated with a second beam direction. The first reference signal and the second reference signal, in some aspects, have a quasi co-location (QCL) type D relationship with a pair of TCI states or with a single TCI state that includes a parameter to indicate multiple beams. In a first example, the CSI report may report a pair of unified TCIs. In another example, the CSI report may report a single TCI state that corresponds to two reference signals, e.g., a TCI with a parameter of M=2, N=2, which provides a number of M=2 source reference signals for the beam indication to DL channels and also a number of N=2 source reference signals for the beam indication to UL channels.

At 414, the UE 402 may first identify a pair of unified TCIs or a unified TCI with a parameter M=2, N=2 based on measurements of the reference signals 412. The QCL type D source reference signals in the identified TCIs correspond to the reference signals in the CSI report 416 or may be QCLed to the reported reference signals in the CSI report 416. The UE 402, and the base station 404, may determine the applicable channels, to which the beam switch is to apply, based on the unified TCI(s) indicated in the CSI report 416. If the TCI(s) are applicable to uplink channels, the UE 402 may also apply power control parameters based on the unified TCI(s) reported in the CSI report.

In some aspects, the UE 402 may report a CSI report applicable for m-TRP operation with a TCI that is not a unified TCI and that is applicable only to a single DL channel. In such examples, the UE may report at least two reference signals in the CSI report 416 for beam switching. The UE may identify a pair of TCIs and may report the RS that are the QCL-type D source RS in the TCIs or that has a QCL relationship to the source RS of the TCIs. The UE may then determine PDSCH occasions to which the pair of TCIs are to be applied.

The CSI report, in some aspects, is one of a non-group-based CSI report, a group-based CSI report, or a multi-beam CSI report for inter-cell m-TRP. For a non-group-based report, the CSI report may be configured to report resource indices from a single channel measurement resource set independently or serially. For a group-based report, the CSI report may be configured to report a group of resource indices from a single channel measurement resource set, where the group of resource indices may be received simultaneously. For a multi-beam CSI report for inter-cell m-TRP, the CSI report may be configured to report multiple groups of resource indices from two different channel measurement resource sets, where each group of resource indices may be received simultaneously. The CSI report 416 may indicate one or more reference signals associated with at least one of an UL channel and/or a DL channel. For example, a reference signal may be associated with at least one of a PDCCH, a time-domain multiplexed (TDM) PDSCH, a frequency-domain multiplexed (FDM) PDSCH, a spatial-domain multiplexed (SDM) PDSCH, PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, a reference signal may be associated with a channel measurement resource (CMR) set.

Based on the CSI report 416, the UE 402 may switch 418A, and the base station 404 may switch 418B (collectively performing a beam switch 418), for one or more channels, to use a first beam direction associated with a first reference signal included in the CSI report with a first TRP of multiple TRPs of the base station 404. In some aspects the beam switch 418 performed by the UE 402 (e.g., switch 418A) may occur before an indication to switch beams is received from the base station 404. The UE 402, and the base station 404, may identify one or more TCI states (or a unified TCI state) that is associated (e.g., via a QCL-Type D relationship) with a set of reported reference signals (e.g., in a group-based CSI report) and perform beam switch 418 (e.g., 418A or 418B) based on the identified one or more TCI states. In some aspects, the UE 402 and the base station 404 may switch, for the one or more channels, to use the second beam direction with a second TRP of multiple TRPs at the base station.

After the beam switch 418, the UE 402 may communicate (e.g., transmit or receive data) with base station 404 via the transmission(s) 420 using the first beam direction associated with the first reference signal included in the CSI report 416. In some aspects, the transmission(s) 420 may include transmitting or receiving a control channel (e.g., PDCCH or PUCCH), in a single downlink control information (sDCI) operation with the multiple TRPs, based on the first beam direction. In such an example, for PDCCH or PUCCH without repetition in an sDCI m-TRP configuration (e.g., as illustrated in FIG. 4B), the UE and the base station may identify one unified TCI from the pair of unified TCIs or one of the beams indicated by the single unified TCI that indicates two reference signals.

If the unified TCI is for PDSCH/PUSCH occasions or for PDCCH/PUCCH with repetition occasions in a sDCI m-TRP configuration (e.g., as illustrated in FIG. 4B), the UE 402 and the base station 404 may apply the beam switch based on the pair of unified TCIs or the unified TCI indicated two reference signals, e.g., to two occasions, rather than applying a beam switch based on only one of the reference signals. In such an example, the transmission(s) 420 (e.g., PDCCH/PUCCH/PDSCH/PUSCH) may include transmitting or receiving a first transmission of the one or more channels in a first occasion based on the first beam direction and transmitting or receiving a repetition of the one or more channels in a second occasion based on a second beam direction associated with a second reference signal included in the CSI report 416. For example, the first occasion and the second occasion may be transmitted in a FDM manner or in a SDM manner, and the CSI report 416 may include a group-based CSI report or a multi-beam CSI report for inter-cell TRPs or the first occasion and the second occasion may be transmitted in a TDM manner, and the CSI report 416 may include a non-group-based CSI report, a group-based CSI report, or a multi-beam CSI report for inter-cell TRPs.

In some aspects, the transmission(s) 420 may be associated with a multiple downlink control information (mDCI) configuration for communication with the multiple TRPs and the transmission(s) 420 (e.g., as illustrated in FIG. 4C). The beam switch may be applied to channels associated with different CORESET pool indices. For example, the UE 402 and base station 404 may transmit or receive a first transmission of the one or more channels associated with a first CORESET based on the first beam direction and transmit or receive a repetition of the one or more channels associated with a second CORESET based on a second beam direction associated with a second reference signal included in the CSI report 416. For example, the first occasion and the second occasion may be transmitted in a FDM manner or in a SDM manner, and the CSI report 416 may include a group-based CSI report or a multi-beam CSI report for inter-cell TRPs or the first occasion and the second occasion may be transmitted in a TDM manner, and the CSI report 416 may include a non-group-based CSI report, a group-based CSI report, or a multi-beam CSI report for inter-cell TRPs.

The beam switch 418 may be for reception of at least one of a PDCCH, a TDM PDSCH, an FDM PDSCH, an SDM PDSCH, or a PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, the beam switch 418 may be associated with a CMR set. In some aspects, the beam switch 418 may be for reception in an sDCI configuration for the multiple TRPs at the base station 404, and the beam switch 418 to the first beam direction may be based on a first reported reference signal in the non-group-based CSI report. For multiple reported reference signals, the beam switch 418, in some aspects, may include a switch to a first beam direction and a second beam direction based on an order in which the first reference signal and the second reference signal are reported in the CSI report (e.g., a group-based CSI report). In some aspects, the beam switch 418 may include a switch to a first beam direction and a second beam direction based on a characteristic (e.g., an identifier) associated with the reference signal or an associated TCI state, where the characteristic may be used to order the first beam direction and the second beam direction (e.g., ordering TCI state identifiers from lowest to highest).

In some aspects, the CSI report 416 may be a multi-beam CSI report for inter-cell m-TRP and the beam switch 418 to the first beam direction may be to receive a first channel based on an association with a PCI. The first channel may be further associated with at least one of a single CORESET pool index or a set of more than one CORESET pool indexes. In some aspects, additional RRC configuration may be provided to enable associating a reference signal (and associated TCI state) with more than one CORESET.

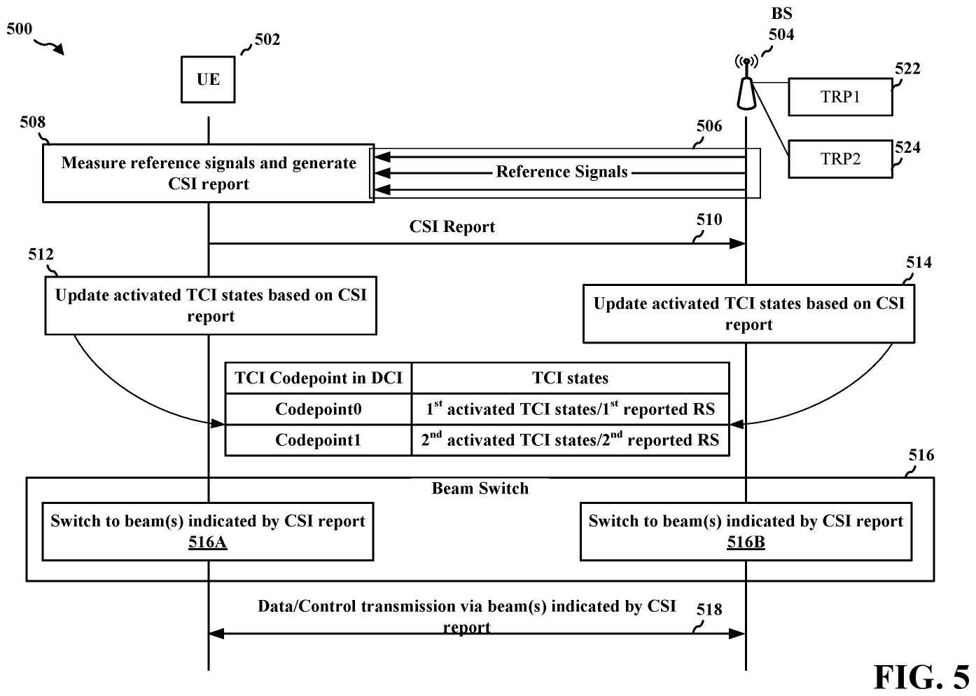

FIG. 5 is a call flow diagram 500 illustrating an implicit update to activated TCI states for beam switching for a UE 502 communicating with a base station 504, e.g., without the UE receiving a MAC-CE activating a TCI state based on a reported reference signal. As described in connection with FIGS. 4B and 4C, the UE 502 and base station 504 may communicate via mTRPs 522 and 524 at the base station 504 (and/or at the UE 502). Diagram 500 illustrates that a base station 504 may then transmit, and the UE 502 may receive, a set of reference signals 506. The UE may measure 508 the received set of reference signals 506 to identify a preferred beam for future communication and generate a CSI report. The UE 502 may then transmit, and the base station 504 may receive, a CSI report 510. The CSI report 510, in some aspects, may be a CSI report based on a set of reference signals (e.g., reference signals in the received set of reference signals 506), the set of reference signals may include, e.g., a first reference signal associated with a first beam direction and a second reference signal associated with a second beam direction. The first reference signal and the second reference signal, in some aspects, have a quasi co-location (QCL) type D relationship with a pair of TCI states or with a single TCI state that includes a parameter to indicate multiple beams. The CSI report, in some aspects, is one of a non-group-based CSI report, a group-based CSI report, or a multi-beam CSI report for inter-cell m-TRP. The CSI report 510 may indicate one or more reference signals associated with at least one of an UL channel and/or a DL channel. For example, a reference signal may be associated with at least one of a PDCCH, a TDM PDSCH, an FDM PDSCH, an SDM PDSCH, or a PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, a reference signal may be associated with a channel measurement resource (CMR) set.

Based on the CSI report 510, the UE may update 512 a set of associations between TCI codepoints in DCI (e.g., values from 0 to 7 that may be indicated in a DCI field) and activated TCI states. In some aspects, the update 512 performed by the UE 502 and the update 514 performed by base station 504 may occur before an activation of a transmission configuration indicator (TCI) state is received from the base station 504. Additionally, based on the CSI report 510, the base station 504 may update 514 a set of associations between TCI codepoints in DCI (e.g., values from 0 to 7 that may be indicated in a DCI field) and activated TCI states. The updated association between TCI codepoints and activated TCI states may be based on an order in which a first reference signal and a second reference signal are reported in the CSI report (e.g., a group-based CSI report). In some aspects, the update 512 or 514 may include an update to a first activated TCI state and a second activated TCI state based on a characteristic (e.g., an identifier) associated with the reference signal or the associated TCI state, where the characteristic may be used to order the first beam direction and the second beam direction (e.g., ordering TCI state identifiers from lowest to highest).

Based on the CSI report 510, the UE 502 may switch 516A, and the base station 504 may switch 516B (collectively performing a beam switch 516), for one or more channels, to use a first beam direction associated with a first reference signal included in the CSI report with a first TRP of multiple TRPs of the base station 504. In some aspects the beam switch 516 performed by the UE 502 (e.g., switch 516A) may occur before an indication to switch beams is received from the base station 504. The UE 502, and the base station 504, may identify one or more TCI states (or a unified TCI state) that is associated (e.g., via a QCL-Type D relationship) with a set of reported reference signals (e.g., in a group-based CSI report) and perform a beam switch 516 (e.g., 516A or 516B) based on the identified one or more TCI states. In some aspects, the UE 502 and the base station 504 may switch, for the one or more channels, to use the second beam direction with a second TRP of multiple TRPs at the base station.

After the beam switch 516, the UE 502 may communicate (e.g., transmit or receive data or control channels) with base station 504 via transmission(s) 518 using the first beam direction associated with one reference signal indicated in the CSI report, such as the first reference signal included in the CSI report 510. In some aspects, the transmission(s) 518 may include transmitting or receiving a control channel (e.g., PDCCH or PUCCH), in a sDCI operation with one of the multiple TRPs (e.g., such as illustrated in FIG. 4B), based on the first beam direction and without repetition.

The transmission(s) 518, in some aspects, may include transmitting or receiving a first transmission of the one or more channels (e.g., PDSCH/PUSCH or PDCCH/PUCCH with configured repetitions) in a first occasion based on the first beam direction and transmitting or receiving a repetition of the one or more channels in a second occasion based on a second beam direction associated with a second reference signal included in the CSI report 510. For example, the first occasion and the second occasion may be in a FDM manner or in a SDM manner, and the CSI report 510 may include a group-based CSI report or a multi-beam CSI report for inter-cell TRPs or the first occasion and the second occasion may be in a TDM manner, and the CSI report 510 may include a non-group-based CSI report, a group-based CSI report, or a multi-beam CSI report for inter-cell TRPs.

In some aspects, the transmission(s) 518 may be associated with an mDCI configuration for communication with the multiple TRPs (e.g., as illustrated in FIG. 4C) and the transmission(s) 518 may include transmitting or receiving a first transmission of the one or more channels associated with a first CORESET based on the first beam direction and transmitting or receiving a repetition of the one or more channels associated with a second CORESET based on a second beam direction associated with a second reference signal included in the CSI report 510. For example, the first occasion and the second occasion may be in a FDM manner or in a SDM manner, and the CSI report may include a group-based CSI report or a multi-beam CSI report for inter-cell TRPs or the first occasion and the second occasion may be in a TDM manner, and the CSI report may include a non-group-based CSI report, a group-based CSI report, or a multi-beam CSI report for inter-cell TRPs.

The beam switch 516 may be for reception of at least one of a PDCCH, a TDM PDSCH, a FDM PDSCH, a SDM PDSCH, PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, the beam switch 516 may be associated with a CMR set. In some aspects, the beam switch 516 may be for reception in an sDCI configuration for the multiple TRPs at the base station 504, and the beam switch 516 to the first beam direction may be based on a first reported reference signal in the non-group-based CSI report. For multiple reported reference signals, the beam switch 516, in some aspects, may include a switch to a first beam direction and a second beam direction based on an order in which the first reference signal and the second reference signal are reported in the CSI report (e.g., a group-based CSI report). In some aspects, the beam switch 516 may include a switch to a first beam direction and a second beam direction based on a characteristic (e.g., an identifier) associated with the reference signal or an associated TCI state, where the characteristic may be used to order the first beam direction and the second beam direction (e.g., ordering TCI state identifiers from lowest to highest).

In some aspects, the CSI report 510 may be a multi-beam CSI report for inter-cell m-TRP and the beam switch 516 to the first beam direction may be to receive a first channel based on an association with a PCI. The first channel may be further associated with at least one of a single CORESET pool index or a set of more than one CORESET pool indexes. In some aspects, additional RRC configuration may be provided to enable associating a reference signal (and associated TCI state) with more than one CORESET pool index.

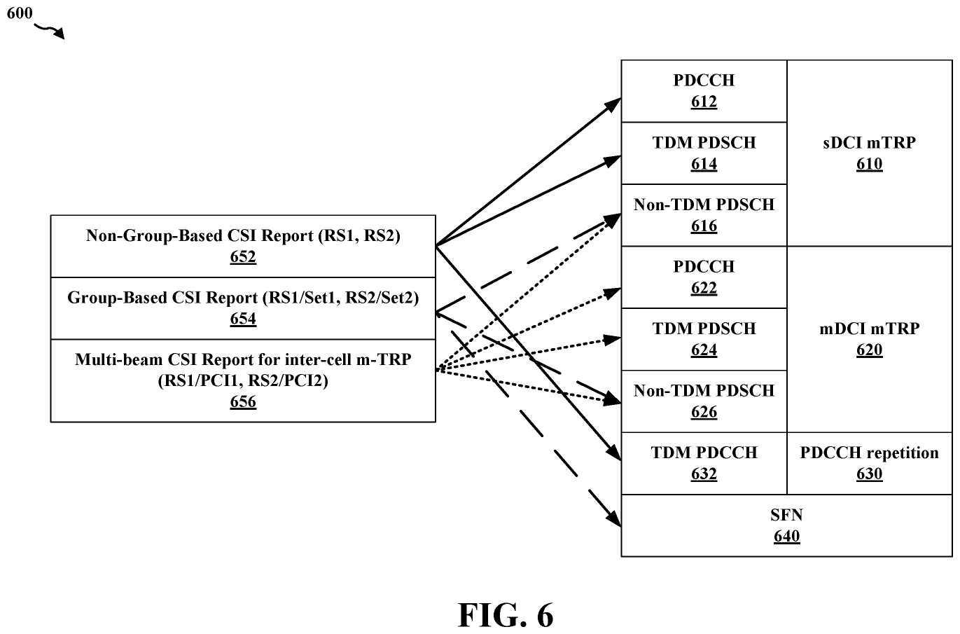

FIG. 6 is a diagram 600 summarizing the relation between different types of CSI reports (e.g., non-group-based CSI report 652, group-based CSI report 654, or multi-beam CSI report for inter-cell m-TRP 656) that may be transmitted by a UE and types of channels (e.g., PDCCH 612, 622, 632; PDSCH 614, 616, 624, 626; or channel of SFN 640) that may be associated with the reference signals indicated in the CSI report (e.g., the CSI report 416 or 510). In some aspects, the relation between the different types of CSI reports that may be transmitted by a UE and corresponding UL channels may mirror the relation between the CSI reports and the DL channels. For example, a non-group-based CSI report 652 (or set of non-group-based CSI reports) may include at least a first reference signal (RS1) and a second reference signal (RS2) and may be associated with a PDCCH 612 or a TDM PDSCH 614 associated with sDCI mTRP 610 or a set of TDM PDCCH with repetitions configured.

In a first example for the non-group cased CSI report, the UE may apply the beam switch (e.g., at 418 or 516) to a PDCCH for an sDCI m-TRP configuration. In this example, the UE and the base station may update the TCI QCLed with a first reported reference signal in the CSI report 416 or 510 to all the CORESETs that the UE monitors for the PDCCH. The UE may apply a similar rule for an uplink control channel, e.g., PUCCH for an sDCI m-TRP configuration without repetition.

In a second example for the non-group cased CSI report, the UE and the base station may apply the beam switch (e.g., at 418 or 516) to TDM PDSCH occasions for an sDCI m-TRP configuration. In this example, the UE and the base station may update the TCI QCLed with a first reported reference signal in the CSI report 416 or 510 for a first PDSCH occasion and may apply a second reported reference signal in the CSI report for a second PDSCH occasion. The UE may apply a similar rule for a corresponding uplink channel, e.g., TDM PUSCH.

In a third example for the non-group cased CSI report, the UE and the base station may apply the beam switch (e.g., at 418 or 516) to PDCCH with repetitions configured in two SS sets of two CORESETs. In this example, the UE and the base station may update the TCI QCLed with a first reported reference signal in the CSI report 416 or 510 to monitor for the PDCCH the first SS set and may apply a second reported reference signal in the CSI report to monitor for the PDCCH in the second SS set. The UE may apply a similar rule for a corresponding uplink channel, e.g., PUCCH.

In a fourth example for the non-group cased CSI report, the UE and the base station may apply the beam switch (e.g., at 418 or 516) to SFN transmissions of PDCCH and/or PDSCH, e.g., based on an SFN configuration. In this example, the UE and the base station may update the TCI QCLed with a first reported reference signal and the second reported reference signal in the CSI report 416 or 510 to monitor for the SFN PDCCH and/or PDSCH. The UE may apply a similar rule for a corresponding uplink channel, e.g., SFN PUSCH/PUCCH.

In a fifth example for the non-group cased CSI report, the UE and the base station may apply the beam switch (e.g., at 418 or 516) to PDCCH or PDSCH associated with a preconfigured CORESET pool index in an mDCI m-TRP configuration. In this example, the UE and the base station may update the TCI QCLed with a first reported reference signal in the CSI report 416 or 510 to channels associated with a CORESET pool index. The UE may apply a similar rule for a corresponding uplink channel.

In some aspects, a group-based CSI report 654 may include at least a first reference signal (RS1) (or a first CMR set, “Set1”) and a second reference signal (RS2) (or a second CMR set, “Set2”) and may be associated with non-TDM PDSCH 616 associated with sDCI mTRP 610, a non-TDM PDSCH 626 associated with mDCI mTRP 620, or a channel associated with a single frequency network 640. In some aspects, a multi-beam CSI report for intercell m-TRP may include at least a first reference signal (RS1) (associated with a first PCI, “PCI1”) and a second reference signal (RS2) associated with a second PCI, “PCI2”) and may be associated with non-TDM PDSCH 616 associated with sDCI mTRP 610, one of a PDCCH 622, a TDM PDSCH 624, or a non-TDM PDSCH 626 associated with mDCI mTRP 620, or a TDM PDCCH associated with PDCCH repetition 630.

In a first example for the group case CSI report, the UE and the base station may apply the beam switch (e.g., at 418 or 516) to FDM PDSCH in an sDCI m-TRP configuration. In this example, the UE and the base station may update the TCI QCLed with a first reported reference signal and the second reported reference signal in the CSI report 416 or 510 to two PDSCHs in order of the FDM occasions. The UE and the base station may apply the beam switch (e.g., at 418 or 516) to SDM PDSCH in an sDCI m-TRP configuration. In this example, the UE and the base station may update the TCI QCLed with a first reported reference signal and the second reported reference signal in the CSI report 416 or 510 to two PDSCHs in order of the SDM occasions. The UE may apply a similar rule for a corresponding uplink channel, e.g., FDM or SDM PUSCH.

In a second example for the group case CSI report, the UE and the base station may apply the beam switch (e.g., at 418 or 516) to PDCCH with repetitions configured in two SS sets of two CORESETs. In this example, the UE and the base station may update the TCI QCLed with a first reported reference signal and the second reported reference signal in the CSI report 416 or 510 to two PDCCHs repetitions in order, e.g., the TCI QCLed with the first reported reference signal to a first PDCCH repetition and the TCI QCLed with the second reported reference signal to a second PDCCH repetition. The UE may apply a similar rule for a corresponding uplink channel, e.g., PUCCH repetitions.

In a third example for the group case CSI report, the UE and the base station may apply the beam switch (e.g., at 418 or 516) to PDCCH/PDSCH associated with a CORESET pool in the mDCI m-TRP configuration. As an example, the UE and the base station may update the TCI QCLed with a first reported reference signal for a channel associated with no CORESET and the TCI QCLed with the second reported reference signal in the CSI report for a channel associated with a first CORESET index. As another example, the UE and the base station may update the TCI QCLed with a first reported reference signal for a channel associated with a first CORESET index and the TCI QCLed with the second reported reference signal in the CSI report for a channel associated with a second CORESET index. The UE may apply a similar rule for a corresponding uplink channel.

In an example for a group-based CSI report for an implicit beam switch, the UE and the base station may apply the beam switch (e.g., at 418 or 516) to FDM or SDM PDSCH for an sDCI m-TRP configuration. In this example, the UE and the base station may update the TCI state QCLed with the reference signal in a first CMR set and the TCI state QCLed with the reference signal in a second CMR set for two PDSCHs based on an order of FDM occasion or SDM occasion, e.g., a 1st TCI state QCLed with the reference signal in the first CMR to the first FDM PDSCH occasion and a 2nd TCI state QCLed with the reference signal in the second CMR to the second FDM PDSCH occasion, or a 1st TCI state QCLed with the reference signal in the first CMR to the first SDM PDSCH occasion and a 2nd TCI state QCLed with the reference signal in the second CMR to the second SDM PDSCH occasion. The UE may apply a similar rule for a corresponding uplink channel.

In another group-based CSI report example, the UE and the base station may apply the beam switch (e.g., at 418 or 516) to PDCCH repetition in two SS sets of two CORESETs. The UE and the base station may update the TCI state pair QCLed with the reference signal in a first CMR set for a first PDCCH repetition and TCI state QCLed with the reference signal in a second CMR set to a second PDCCH occasion. The UE may apply a similar rule for a corresponding uplink channel.

In another group-based CSI report example, the UE and the base station may apply the beam switch (e.g., at 418 or 516) to PDSCH/PDCCH associated with a configured CORESET pool in an mDCI m-TRP configuration. As an example, the UE and the base station may update the TCI QCLed with a reference signal in a first CMR set for a channel associated with no CORESET and the TCI QCLed with the reference signal in the second CMR set for a channel associated with a first CORESET index. As another example, the UE and the base station may update the TCI QCLed with a reference signal in the first CMR set for a channel associated with a first CORESET index and the TCI QCLed with the reference signal in the second CMR set for a channel associated with a second CORESET index. The UE may apply a similar rule for a corresponding uplink channel.

In some aspects, the CSI report 416 or 510 may be a multi-beam CSI report for inter-cell m-TRP reporting, e.g., 656 in FIG. 6. The UE may apply the TCI QCLed with RS of different PCIs for different channels. In some aspects, one PCI that is associated with one or more activated TCI states for PDCCH or PDSCH may be associated with a single CORESET index. In some aspects, one PCI that is associated with one or more activated TCI states for PDCCH or PDSCH may be associated with more than one CORESET pool index. In some aspects, the UE may receive an RRC configuration from the base station for the applicable channels and TCI states.

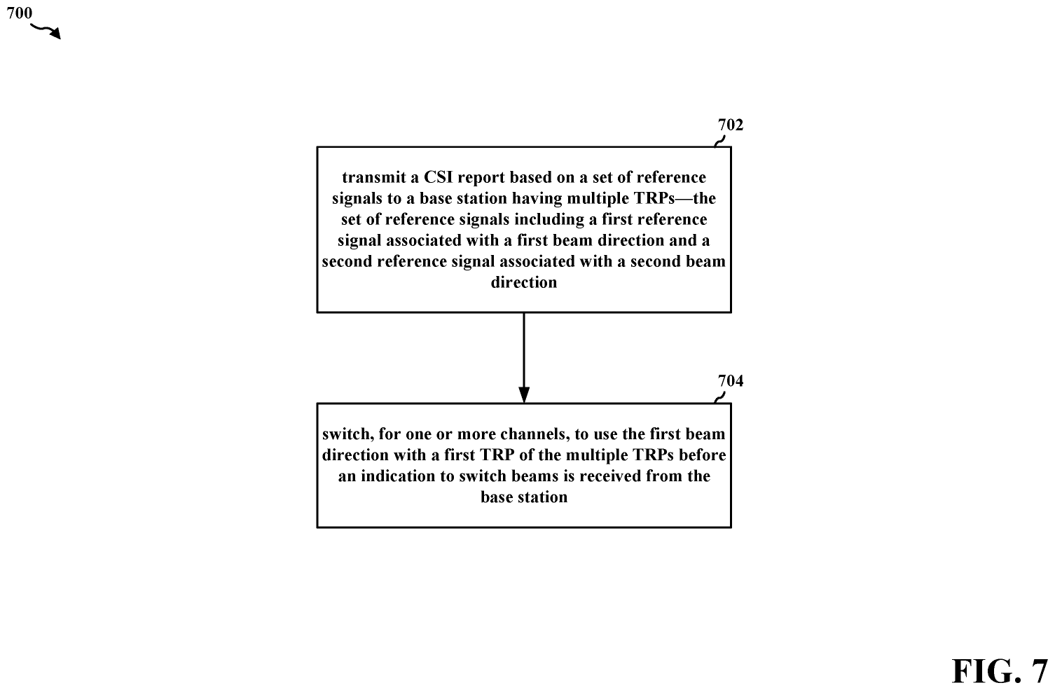

FIG. 7 is a flowchart 700 of a method of wireless communication. The method may be performed by a UE (e.g., the UE 104, 402, or 502; the apparatus 1102). The method may enable the UE to initiate an implicit beam switch in response to a CSI report to a base station for m-TRP communication.

At 702, the UE may transmit a CSI report based on a set of reference signals to a base station having multiple TRPs. In some aspects, the set of reference signals may include a first reference signal associated with a first beam direction and a second reference signal associated with a second beam direction. For example, 702 may be performed by CSI report component 1140. The first reference signal and the second reference signal, in some aspects, have a QCL type D relationship with a pair of TCI states or with a single (e.g., unified) TCI state that includes a parameter to indicate multiple beams.

The CSI report, in some aspects, is one of a non-group-based CSI report, a group-based CSI report, or a multi-beam CSI report for inter-cell m-TRP. The CSI report may indicate one or more reference signals to switch beams associated with at least one of an UL channel and/or a DL channel. For example, the beam switch may be applied to at least one of a PDCCH, a TDM PDSCH, an FDM PDSCH, an SDM PDSCH, PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, a reference signal may be associated with a channel measurement resource (CMR) set. The beam switch may be applied, in some aspects, to at least one of a PUCCH, a TDM PUSCH, an FDM PUSCH, an SDM PUSCH, a PUCCH with repetitions configured in two search space sets of two CORESETs, a single frequency network PUCCH, a single frequency network PUSCH, a PUCCH associated with a CORESET pool index, or a PUSCH associated with the CORESET pool index. For example, referring to FIGS. 4 and 5, the UE 402 (or 502) may transmit CSI report 416 (or 510) to the base station 404 (or 504). At 704, the UE may switch, for one or more channels, to use the first beam direction with a first TRP of the multiple TRPs based on the set of reference signals before receiving any transmission corresponding to the first beam direction from the base station. The UE may identify one or more TCI states (or a unified TCI state) that is associated (e.g., via a QCL-Type D relationship) with a set of reported reference signals (e.g., in a group-based CSI report) and switch beams based on the identified one or more TCI states. In some aspects, the UE may also switch, for the one or more channels, to use the second beam direction with a second TRP of multiple TRPs at the base station. For example, referring to FIGS. 4 and 5, the UE 402 (or the UE 502) may perform beam switch 418 (or 516) for at least one channel based on the CSI report 416 (or 510) and use at least one switched beam for subsequent transmission(s) 420 (or 518) via the at least one channel. For example, 704 may be performed by beam switching component 1142.

In some aspects, switching to use the first beam direction with a first TRP of the multiple TRPs at 704 may include updating a set of associations between TCI codepoints in DCI (e.g., values from 0 to 7 that may be indicated in a DCI field) and activated TCI states. In some aspects, the update may occur before an activation of a TCI state is received from a base station. The updated association between TCI codepoints and activated TCI states may be based on an order in which a first reference signal and a second reference signal are reported in the CSI report (e.g., a group-based CSI report). In some aspects, the update may include an update to a first activated TCI state and a second activated TCI state based on a characteristic (e.g., an identifier) associated with the reference signal or the associated TCI state, where the characteristic may be used to order the first beam direction and the second beam direction (e.g., ordering TCI state identifiers from lowest to highest). For example, referring to FIG. 5, the UE 502 may update 512 an activated TCI state for at least one channel based on the CSI report 510 and use at least one switched beam for subsequent transmission(s) 518 via the at least one channel. For example, 704 may be performed by activated TCI state updating component 1144.

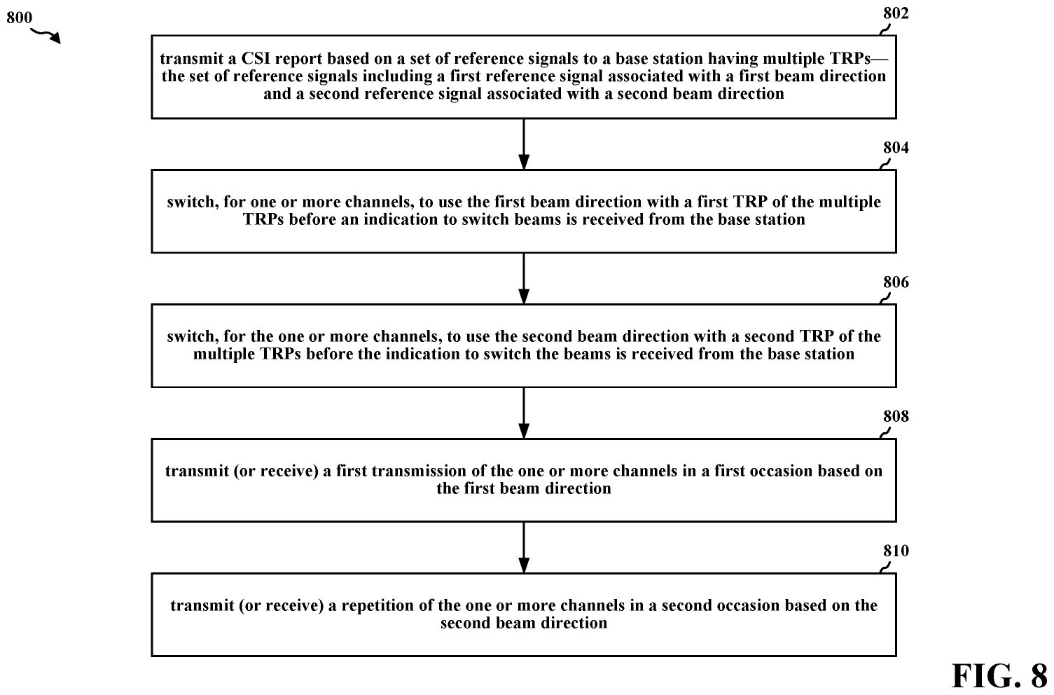

FIG. 8 is a flowchart 800 of a method of wireless communication. The method may be performed by a UE (e.g., the UE 104, 402, or 502; the apparatus 1102). At 802, the UE may transmit a CSI report based on a set of reference signals to a base station having multiple TRP. In some aspects, the set of reference signals may include a first reference signal associated with a first beam direction and a second reference signal associated with a second beam direction. For example, 802 may be performed by CSI report component 1140. The first reference signal and the second reference signal, in some aspects, have a QCL type D relationship with a pair of TCI states or with a single (e.g., unified) TCI state that includes a parameter to indicate multiple beams. The CSI report, in some aspects, is one of a non-group-based CSI report, a group-based CSI report, or a multi-beam CSI report for inter-cell m-TRP. The CSI report may indicate one or more reference signals associated with at least one of an UL channel and/or a DL channel. For example, a reference signal may be indicated to switch beams for at least one of a PDCCH, a TDM PDSCH, an FDM PDSCH, an SDM PDSCH, a PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, a reference signal may be associated with a channel measurement resource (CMR) set. The beam switch, in some aspects, may similarly be applied to at least one of a PUCCH, a TDM PUSCH, an FDM PUSCH, an SDM PUSCH, a PUCCH with repetitions configured in two search space sets of two CORESETs, a single frequency network PUCCH, a single frequency network PUSCH, a PUCCH associated with a CORESET pool index, or a PUSCH associated with the CORESET pool index. For example, referring to FIGS. 4 and 5, the UE 402 (or 502) may transmit CSI report 416 (or 510) to the base station 404 (or 504).

At 804, the UE may switch, for one or more channels, to use the first beam direction with a first TRP of the multiple TRPs based on the set of reference signals before receiving any transmission corresponding to the first beam direction from the base station. The UE may identify one or more TCI states (or a unified TCI state) that is associated (e.g., via a QCL-Type D relationship) with a set of reported reference signals (e.g., in a group-based CSI report) and switch beams based on the identified one or more TCI states. In some aspects, the CSI report is a multi-beam CSI report for inter-cell m-TRP and the UE switches, at 804, to using the first beam direction to receive a first channel based on an association with a physical cell ID. The first channel, in some aspects, may be further associated with at least one of a single control resource set (CORESET) pool index or a set of more than one CORESET pool index. For example, referring to FIGS. 4 and 5, the UE 402 (or the UE 502) may perform beam switch 418 (or 516) for at least one channel to use a first beam direction with a first TRP of the multiple TRPs based on the CSI report 416 (or 510). For example, 804 may be performed by beam switching component 1142.

In some aspects, switching to use the first beam direction with a first TRP of the multiple TRPs at 804 may include updating a set of associations between TCI codepoints in DCI (e.g., values from 0 to 7 that may be indicated in a DCI field) and activated TCI states. In some aspects, the update may occur before an activation of a TCI state is received from a base station. The updated association between TCI codepoints and activated TCI states may be based on an order in which a first reference signal and a second reference signal are reported in the CSI report (e.g., a group-based CSI report). In some aspects, the update may include an update to a first activated TCI state and a second activated TCI state based on a characteristic (e.g., an identifier) associated with the reference signal or the associated TCI state, where the characteristic may be used to order the first beam direction and the second beam direction (e.g., ordering TCI state identifiers from lowest to highest). For example, referring to FIG. 5, the UE 502 may update 512 an activated TCI state for at least one channel based on the CSI report 510 and use at least one switched beam for subsequent transmission(s) 518 via the at least one channel. For example, 804 may also be performed by activated TCI state updating component 1144.

At 806, the UE may switch, for the one or more channels, to use the second beam direction with a second TRP of the multiple TRPs based on the set of reference signals before receiving any transmission corresponding to the first beam direction from the base station. The UE may identify one or more TCI states (or a unified TCI state) that is associated (e.g., via a QCL-Type D relationship) with a set of reported reference signals (e.g., in a group-based CSI report) and switch beams based on the identified one or more TCI states. For example, referring to FIGS. 4 and 5, the UE 402 (or the UE 502) may perform beam switch 418 (or 516) to use the second beam direction with a second TRP of the multiple TRPs for at least one channel based on the CSI report 416 (or 510). For example, 806 may be performed by beam switching component 1142.

In some aspects, the CSI report is a group-based CSI report and the UE may switch to the first beam direction, at 804, and the second beam, at 806, for reception of the one or more channels based on an order in which the first reference signal and the second reference signal are reported in the CSI report. The CSI report, in some aspects, may be a group-based CSI report and the UE may switch to the first beam direction, at 804, based on the first reference signal in a first CMR set and the second beam direction, at 806, based on the second reference signal in a second CMR set for reception of one or more channels.

At 808, the UE may transmit (or receive) a first transmission of the one or more channels in a first occasion based on the first beam direction. For example, 806 may be performed by beam switching component 1142. The one or more channels may include one of, a PDCCH, a PDSCH, a PUCCH, or a PUSCH. The one or more channels may be associated with (1) two search space sets of two CORESETs, (2) a single frequency network, (3) one or more CORESET pool index(es), (4) an sDCI configuration, or (5) an mDCI configuration. In some aspects, the data transmissions associated with the one or more channels may be FDM data transmissions, TDM data transmissions, or SDM data transmissions. For example, referring to FIGS. 4 and 5, the UE 402 (or the UE 502) may transmit, or receive, transmission(s) 420 (or 518) via the at least one channel base on the beam switch 418 (or 516) to use the first beam direction with a first TRP of the multiple TRPs for at least one channel based on the CSI report 416 (or 510).

For example, in some aspects, the one or more channels may include a control channel, in an sDCI operation with the multiple TRPs. In some aspects, the one or more channels may include at least one of a PDCCH, a TDM PDSCH, an FDM PDSCH, an SDM PDSCH, PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, the UE switches to the first beam direction for reception in an sDCI configuration for the multiple TRPs, where the switching to the first beam direction is based on a first reported reference signal in the non-group-based CSI report transmitted at 804.

At 810, the UE may transmit (or receive) a second transmission of the one or more channels in a second occasion based on the second beam direction. For example, 810 may be performed by beam switching component 1142. The one or more channels may include one of, a PDCCH, a PDSCH, a PUCCH, or a PUSCH. The one or more channels may be associated with (1) two search space sets of two CORESETs, (2) a single frequency network, (3) one or more CORESET pool index(es), (4) an sDCI configuration, or (5) an mDCI configuration. In some aspects, the data transmissions associated with the one or more channels may be FDM data transmissions, TDM data transmissions, or SDM data transmissions. For example, referring to FIGS. 4 and 5, the UE 402 (or the UE 502) may transmit, or receive, transmission(s) 420 (or 518) via the at least one channel base on the beam switch 418 (or 516) to use the second beam direction with a second TRP of the multiple TRPs for at least one (e.g., a second) channel based on the CSI report 416 (or 510).

For example, in some aspects, the one or more channels may include a control channel, in an sDCI operation with the multiple TRPs. In some aspects, the one or more channels may include at least one of a PDCCH, a TDM PDSCH, an FDM PDSCH, an SDM PDSCH, PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, the UE switches to the second beam direction for reception in an sDCI configuration for the multiple TRPs, where the switching to the second beam direction is based on a second reported reference signal in the non-group-based CSI report transmitted at 804.

In some aspects, the first occasion and the second occasion are FDM or SDM, and the CSI report is one of a group-based CSI report or a multi-beam CSI report for inter-cell TRPs. The first occasion and the second occasion, in some aspects, are TDM, and the CSI report is one of a non-group-based CSI report, a group-based CSI report, or a multi-beam CSI report for inter-cell TRPs. In some aspects, the transmission or reception of the first transmission of the one or more channels, at 806, may be associated with a first CORESET based on the first beam direction; and the transmission or reception of the second transmission of the one or more channels, at 810, may be a repetition of the one or more channels associated with a second CORESET based on the second beam direction. The first transmission and the repetition, in some aspects, may be transmitted in an FDM manner or in an SDM manner, and the CSI report may be one of a group-based CSI report or a multi-beam CSI report for inter-cell TRPs. In some aspects, the first transmission and the repetition are transmitted in a TDM manner, and the CSI report may be one of a non-group-based CSI report, a group-based CSI report, or a multi-beam CSI report for inter-cell TRPs.

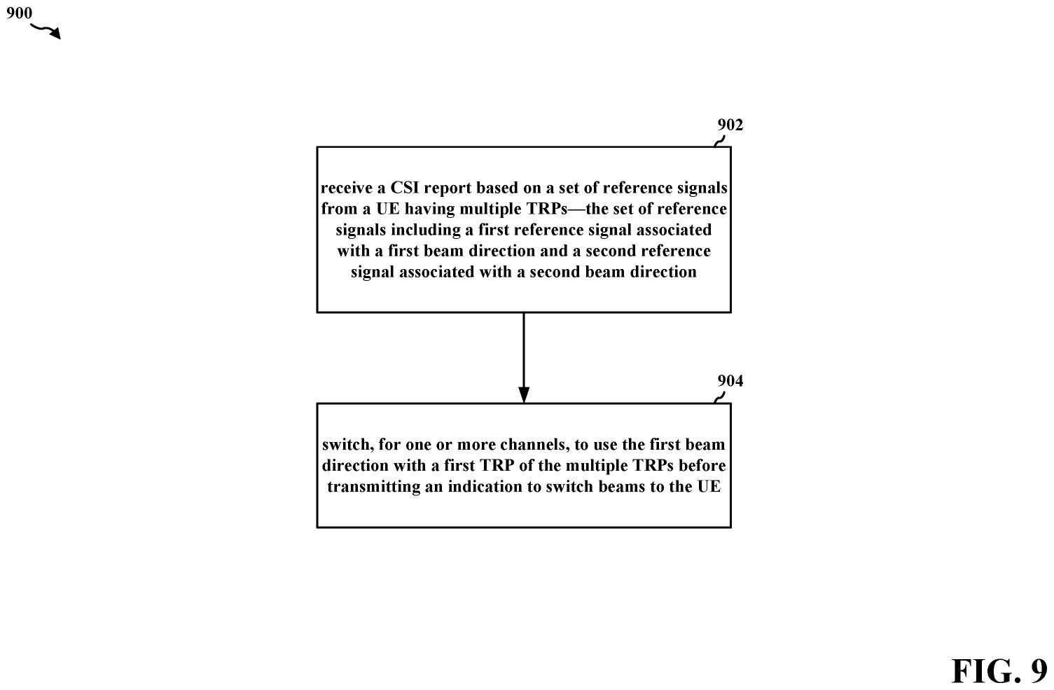

FIG. 9 is a flowchart 900 of a method of wireless communication. The method may be performed by a base station having multiple TRPs (e.g., the base station 102/180, 404, and 504; the apparatus 1202). At 902, the base station may receive a CSI report based on a set of reference signals from a UE. In some aspects, the set of reference signals may include a first reference signal associated with a first beam direction and a second reference signal associated with a second beam direction. For example, 902 may be performed by CSI report reception component 1240. The first reference signal and the second reference signal, in some aspects, have a QCL type D relationship with a pair of TCI states or with a single (e.g., unified) TCI state that includes a parameter to indicate multiple beams. The CSI report, in some aspects, is one of a non-group-based CSI report, a group-based CSI report, or a multi-beam CSI report for inter-cell m-TRP. The CSI report may indicate one or more reference signals associated with at least one of an UL channel and/or a DL channel. For example, a reference signal may be associated with at least one of a PDCCH, a TDM PDSCH, an FDM PDSCH, an SDM PDSCH, a PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, a reference signal may be associated with a channel measurement resource (CMR) set. The TCI state associated with the reference signals may be applied in a beam switch for at least one of a PUCCH, a TDM PUSCH, an FDM PUSCH, an SDM PUSCH, a PUCCH with repetitions configured in two search space sets of two CORESETs, a single frequency network PUCCH, a single frequency network PUSCH, a PUCCH associated with a CORESET pool index, or a PUSCH associated with the CORESET pool index. For example, referring to FIGS. 4 and 5, the base station 404 (or 504) may receipt CSI report 416 (or 510) from the UE 402 (or 502).

At 904, the base station may switch, for one or more channels, to use the first beam direction with a first TRP of the multiple TRPs before an indication to switch beams is transmitted to the UE. The base station may identify one or more TCI states (or a unified TCI state) that is associated (e.g., via a QCL-Type D relationship) with a set of reported reference signals (e.g., in a group-based CSI report) and switch beams based on the identified one or more TCI states. In some aspects, the base station may also switch, for the one or more channels, to use the second beam direction with a second TRP of multiple TRPs at the base station. For example, referring to FIGS. 4 and 5, the base station 404 (or the base station 504) may perform beam switch 418 (or 516) for at least one channel based on the CSI report 416 (or 510) and use at least one switched beam for subsequent transmission(s) 420 (or 518) via the at least one channel. For example, 904 may be performed by beam switching component 1242.

In some aspects, switching to use the first beam direction with a first TRP of the multiple TRPs at 904 may include updating a set of associations between TCI codepoints in DCI (e.g., values from 0 to 7 that may be indicated in a DCI field) and activated TCI states. In some aspects, the update may occur before an activation of a TCI state is transmitted to a UE. The updated association between TCI codepoints and activated TCI states may be based on an order in which a first reference signal and a second reference signal are reported in the CSI report (e.g., a group-based CSI report). In some aspects, the update may include an update to a first activated TCI state and a second activated TCI state based on a characteristic (e.g., an identifier) associated with the reference signal or the associated TCI state, where the characteristic may be used to order the first beam direction and the second beam direction (e.g., ordering TCI state identifiers from lowest to highest). For example, referring to FIG. 5, the base station 504 may update 514 an activated TCI state for at least one channel based on the CSI report 510 and use at least one switched beam for subsequent transmission(s) 518 via the at least one channel. For example, 904 may be performed by activated TCI state updating component 1244.

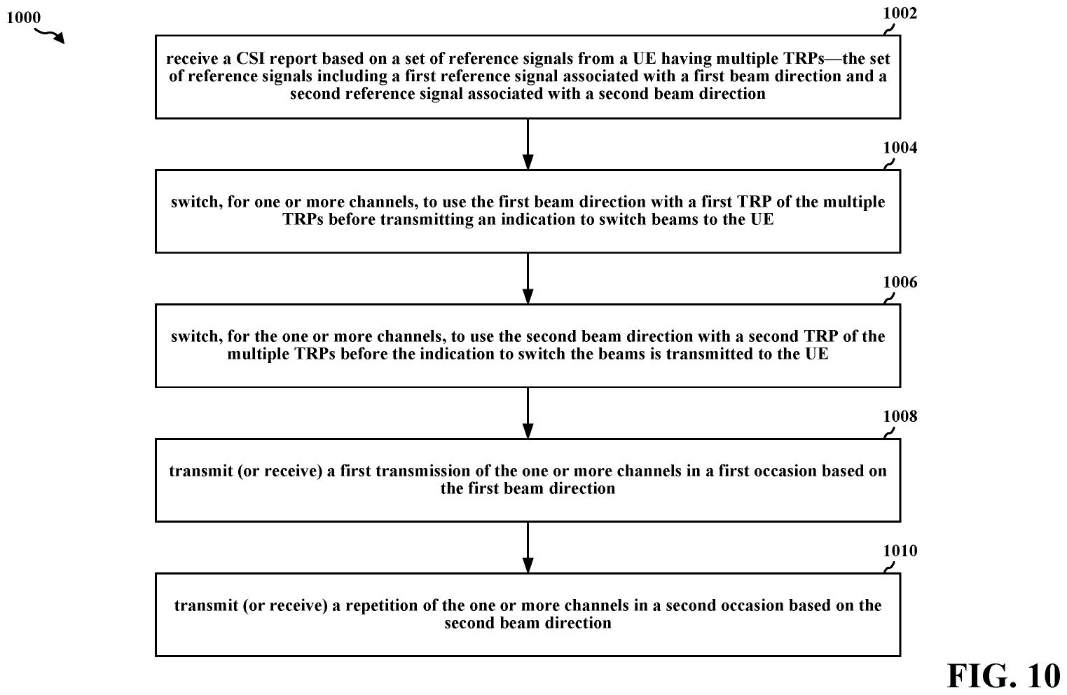

FIG. 10 is a flowchart 1000 of a method of wireless communication. The method may be performed by a base station having multiple TRPs (e.g., the base station 102/180, 404, and 504; the apparatus 1202). At 1002, the base station may receive a CSI report based on a set of reference signals from a UE. In some aspects, the set of reference signals may include a first reference signal associated with a first beam direction and a second reference signal associated with a second beam direction. For example, 1002 may be performed by CSI report reception component 1240. The first reference signal and the second reference signal, in some aspects, have a QCL type D relationship with a pair of TCI states or with a single (e.g., unified) TCI state that includes a parameter to indicate multiple beams. The CSI report, in some aspects, is one of a non-group-based CSI report, a group-based CSI report, or a multi-beam CSI report for inter-cell m-TRP. The CSI report may indicate one or more reference signals associated with at least one of an UL channel and/or a DL channel. For example, a reference signal may be associated with at least one of a PDCCH, a TDM PDSCH, an FDM PDSCH, an SDM PDSCH, a PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, a reference signal may be associated with a channel measurement resource (CMR) set. The TCI states QCLed with the reference signals, in some aspects, may be applied to at least one of a PUCCH, a TDM PUSCH, an FDM PUSCH, an SDM PUSCH, a PUCCH with repetitions configured in two search space sets of two CORESETs, a single frequency network PUCCH, a single frequency network PUSCH, a PUCCH associated with a CORESET pool index, or a PUSCH associated with the CORESET pool index. For example, referring to FIGS. 4 and 5, the base station 404 (or 504) may receive CSI report 416 (or 510) from the UE 402 (or 502).

At 1004, the base station may switch, for one or more channels, to use the first beam direction with a first TRP of the multiple TRPs before an indication to switch beams is transmitted to a UE. The base station may identify one or more TCI states (or a unified TCI state) that is associated (e.g., via a QCL-Type D relationship) with a set of reported reference signals (e.g., in a group-based CSI report) and switch beams based on the identified one or more TCI states. In some aspects, the CSI report is a multi-beam CSI report for inter-cell m-TRP and the base station switches, at 1004, to using the first beam direction to receive a first channel based on an association with a physical cell ID. The first channel, in some aspects, may be further associated with at least one of a single control resource set (CORESET) pool index or a set of more than one CORESET pool index. For example, referring to FIGS. 4 and 5, the base station 404 (or the base station 504) may perform beam switch 418 (or 516) for at least one channel to use a first beam direction with a first TRP of the multiple TRPs based on the CSI report 416 (or 510). For example, 1004 may be performed by beam switching component 1242.

In some aspects, switching to use the first beam direction with a first TRP of the multiple TRPs at 1004 may include updating a set of associations between TCI codepoints in DCI (e.g., values from 0 to 7 that may be indicated in a DCI field) and activated TCI states. In some aspects, the update may occur before an activation of a TCI state is transmitted to a UE. The updated association between TCI codepoints and activated TCI states may be based on an order in which a first reference signal and a second reference signal are reported in the CSI report (e.g., a group-based CSI report). In some aspects, the update may include an update to a first activated TCI state and a second activated TCI state based on a characteristic (e.g., an identifier) associated with the reference signal or the associated TCI state, where the characteristic may be used to order the first beam direction and the second beam direction (e.g., ordering TCI state identifiers from lowest to highest). For example, referring to FIG. 5, the base station 504 may update 512 an activated TCI state for at least one channel based on the CSI report 510 and use at least one switched beam for subsequent transmission(s) 518 via the at least one channel. For example, 1004 may also be performed by activated TCI state updating component 1244.

At 1006, the base station may switch, for the one or more channels, to use the second beam direction with a second TRP of the multiple TRPs before the indication to switch the beams is transmitted to a UE. The base station may identify one or more TCI states (or a unified TCI state) that is associated (e.g., via a QCL-Type D relationship) with a set of reported reference signals (e.g., in a group-based CSI report) and switch beams based on the identified one or more TCI states. For example, referring to FIGS. 4 and 5, the base station 404 (or the base station 504) may perform beam switch 418 (or 516) to use the second beam direction with a second TRP of the multiple TRPs for at least one channel based on the CSI report 416 (or 510). For example, 1006 may be performed by beam switching component 1242.

In some aspects, the CSI report is a group-based CSI report and the base station may switch to the first beam direction, at 1004, and the second beam, at 1006, for reception of the one or more channels based on an order in which the first reference signal and the second reference signal are reported in the CSI report. The CSI report, in some aspects, may be a group-based CSI report and the base station may switch to the first beam direction, at 1004, based on the first reference signal in a first CMR set and the second beam direction, at 1006, based on the second reference signal in a second CMR set for reception of one or more channels.

At 1008, the base station may transmit (or receive) a first transmission of the one or more channels in a first occasion based on the first beam direction. For example, 1006 may be performed by beam switching component 1242. The one or more channels may include one of, a PDCCH, a PDSCH, a PUCCH, or a PUSCH. The one or more channels may be associated with (1) two search space sets of two CORESETs, (2) a single frequency network, (3) one or more CORESET pool index(es), (4) an sDCI configuration, or (5) an mDCI configuration. In some aspects, the data transmissions associated with the one or more channels may be FDM data transmissions, TDM data transmissions, or SDM data transmissions. For example, referring to FIGS. 4 and 5, the base station 404 (or the base station 504) may transmit, or receive, transmission(s) 420 (or 518) via the at least one channel base on the beam switch 418 (or 516) to use the first beam direction with a first TRP of the multiple TRPs for at least one channel based on the CSI report 416 (or 510).

For example, in some aspects, the one or more channels may include a control channel, in an sDCI operation with the multiple TRPs. In some aspects, the one or more channels may include at least one of a PDCCH, a TDM PDSCH, an FDM PDSCH, an SDM PDSCH, a PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, the base station switches to the first beam direction for reception in an sDCI configuration for the multiple TRPs, where the switching to the first beam direction is based on a first reported reference signal in the non-group-based CSI report received at 1004.

At 1010, the base station may transmit (or receive) a second transmission of the one or more channels in a second occasion based on the second beam direction. For example, 1010 may be performed by beam switching component 1242. The one or more channels may include one of, a PDCCH, a PDSCH, a PUCCH, or a PUSCH. The one or more channels may be associated with (1) two search space sets of two CORESETs, (2) a single frequency network, (3) one or more CORESET pool index(es), (4) an sDCI configuration, or (5) an mDCI configuration. In some aspects, the data transmissions associated with the one or more channels may be FDM data transmissions, TDM data transmissions, or SDM data transmissions. For example, referring to FIGS. 4 and 5, the base station 404 (or the base station 504) may transmit, or receive, transmission(s) 420 (or 518) via the at least one channel base on the beam switch 418 (or 516) to use the second beam direction with a second TRP of the multiple TRPs for at least one (e.g., a second) channel based on the CSI report 416 (or 510).

For example, in some aspects, the one or more channels may include a control channel, in an sDCI operation with the multiple TRPs. In some aspects, the one or more channels may include at least one of a PDCCH, a TDM PDSCH, an FDM PDSCH, an SDM PDSCH, a PDCCH with repetitions configured in two search space sets of two CORESETs, a single frequency network PDCCH, a single frequency network PDSCH, a PDCCH associated with a CORESET pool index, or a PDSCH associated with the CORESET pool index. In some aspects, the base station switches to the second beam direction for reception in an sDCI configuration for the multiple TRPs, where the switching to the second beam direction is based on a second reported reference signal in the non-group-based CSI report received at 1004.

In some aspects, the first occasion and the second occasion are FDM or SDM, and the CSI report is one of a group-based CSI report or a multi-beam CSI report for inter-cell TRPs. The first occasion and the second occasion, in some aspects, are TDM, and the CSI report is one of a non-group-based CSI report, a group-based CSI report, or a multi-beam CSI report for inter-cell TRPs. In some aspects, the transmission or reception of the first transmission of the one or more channels, at 1006, may be associated with a first CORESET based on the first beam direction; and the transmission or reception of the second transmission of the one or more channels, at 1010, may be a repetition of the one or more channels associated with a second CORESET based on the second beam direction. The first transmission and the repetition, in some aspects, may be transmitted in an FDM manner or in an SDM manner, and the CSI report may be one of a group-based CSI report or a multi-beam CSI report for inter-cell TRPs. In some aspects, the first transmission and the repetition are transmitted in a TDM manner, and the CSI report may be one of a non-group-based CSI report, a group-based CSI report, or a multi-beam CSI report for inter-cell TRPs.

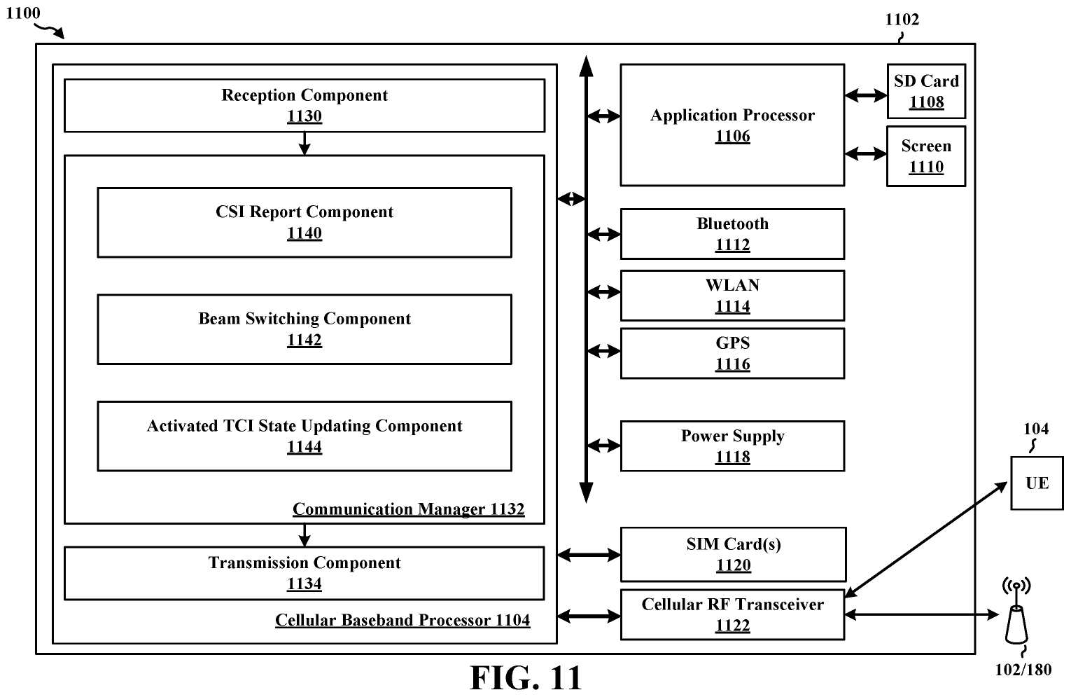

FIG. 11 is a diagram 1100 illustrating an example of a hardware implementation for an apparatus 1102. The apparatus 1102 may be a UE, a component of a UE, or may implement UE functionality. In some aspects, the apparatus 1102 may include a cellular baseband processor 1104 (also referred to as a modem) coupled to a cellular RF transceiver 1122. In some aspects, the apparatus 1102 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory.

The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the additional modules of the apparatus 1102.

The communication manager 1132 includes a CSI report component 1140 that is configured to transmit a CSI report based on a set of reference signals to a base station having multiple TRP, e.g., as described in connection with 702 and 802 of FIGS. 7 and 8. The communication manager 1132 further includes a beam switching component 1142 that receives input in the form of a CSI report from the CSI report component 1140 and is configured to switch, for one or more channels, to use the first beam direction with a first TRP of the multiple TRPs based on the set of reference signals before receiving any transmission corresponding to the first beam direction from the base station and to transmit (or receive) a first transmission (and a second transmission) of the one or more channels in a first occasion based on the first beam direction (and in a second occasion, or repetition, based on the second beam direction), e.g., as described in connection with 704 and 804-810 of FIGS. 7 and 8. The communication manager 1132 further includes an activated TCI state updating component 1144 that receives input in the form of a CSI report from the CSI report component 1140 and is configured to update a set of associations between TCI codepoints in DCI and activated TCI states, e.g., as described in connection with 704 and 804 of FIGS. 7 and 8.

The apparatus may include additional components that perform each of the blocks of the algorithm in the flowcharts of FIGS. 7 and 8. As such, each block in the flowcharts of FIGS. 7 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the cellular baseband processor 1104, includes means for transmitting, to a base station having multiple TRPs, a CSI report based on a set of reference signals, the set of reference signals including a first reference signal associated with a first beam direction and a second reference signal associated with a second beam direction. The apparatus 1102, and in particular the cellular baseband processor 1104, may further include means for switching, for one or more channels, to use the first beam direction with a first TRP of the multiple TRPs based on the set of reference signals before receiving any transmission corresponding to the first beam direction from the base station. The apparatus 1102, and in particular the cellular baseband processor 1104, may further include means for switching, for the one or more channels, to use the second beam direction with a second TRP of the multiple TRPs based on the set of reference signals before receiving any transmission corresponding to the second beam direction from the base station. The apparatus 1102, and in particular the cellular baseband processor 1104, may further include means for transmitting or receiving a control channel, in an sDCI operation with the multiple TRPs, based on the first beam direction. The apparatus 1102, and in particular the cellular baseband processor 1104, may further include means for transmitting or receiving a first transmission of the one or more channels in a first occasion based on the first beam direction. The apparatus 1102, and in particular the cellular baseband processor 1104, may further include means for transmitting or receiving a repetition of the one or more channels in a second occasion based on the second beam direction. The apparatus 1102, and in particular the cellular baseband processor 1104, may further include means for transmitting or receiving a first transmission of the one or more channels associated with a first CORESET based on the first beam direction. The apparatus 1102, and in particular the cellular baseband processor 1104, may further include means for transmitting or receiving a repetition of the one or more channels associated with a second CORESET based on the second beam direction. The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

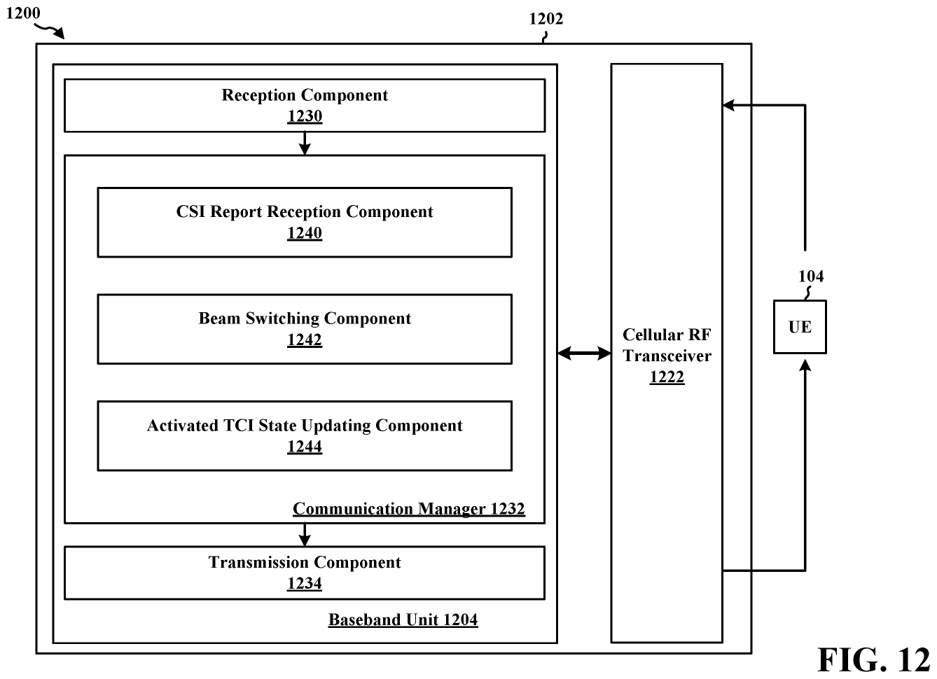

FIG. 12 is a diagram 1200 illustrating an example of a hardware implementation for an apparatus 1202. The apparatus 1202 may be a base station, a component of a base station, or may implement base station functionality. In some aspects, the apparatus 1102 may include a baseband unit 1204. The baseband unit 1204 may communicate through a cellular RF transceiver 1222 with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the base station 310 and may include the memory 376 and/or at least one of the TX processor 316, the RX processor 370, and the controller/processor 375.

The communication manager 1232 includes a CSI report reception component 1240 that is configured to receive a CSI report based on a set of reference signals from a UE, e.g., as described in connection with 902 and 1002 of FIGS. 9 and 10. The communication manager 1232 further includes a beam switching component 1242 that receives input in the form of a CSI report from the CSI report reception component 1240 and is configured to switch, for one or more channels, to use the first beam direction with a first TRP of the multiple TRPs before an indication to switch beams is transmitted to the UE and to transmit (or receive) a first transmission (and a second transmission) of the one or more channels in a first occasion based on the first beam direction (and in a second occasion, or repetition, based on the second beam direction), e.g., as described in connection with 904 and 1004-1010 of FIGS. 9 and 10. The communication manager 1232 further includes an activated TCI state updating component 1244 that receives input in the form of a CSI report from the CSI report reception component 1240 and is configured to update a set of associations between TCI codepoints in DCI and activated TCI states, e.g., as described in connection with 904 and 1004 of FIGS. 9 and 10.

The apparatus may include additional components that perform each of the blocks of the algorithm in the flowcharts of FIGS. 9 and 10. As such, each block in the flowcharts of FIGS. 9 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the baseband unit 1204, includes means for receiving, from a UE, a CSI report based on a set of reference signals, the set of reference signals including a first reference signal associated with a first beam direction and a second reference signal associated with a second beam direction. The apparatus 1202, and in particular the baseband unit 1204, may further include means for switching, for one or more channels, to use the first beam direction with a first TRP of the multiple TRPs before transmitting an indication to switch beams to the UE. The apparatus 1202, and in particular the baseband unit 1204, may further include means for switching, for the one or more channels, to use the second beam direction with a second TRP of the multiple TRPs before the indication to switch the beams is transmitted to the UE. The apparatus 1202, and in particular the baseband unit 1204, may further include means for transmitting or receiving a control channel, in an sDCI operation with the multiple TRPs, based on the first beam. The apparatus 1202, and in particular the baseband unit 1204, may further include means for transmitting or receiving a first transmission of the one or more channels in a first occasion based on the first beam direction. The apparatus 1202, and in particular the baseband unit 1204, may further include means for transmitting or receiving a repetition of the one or more channels in a second occasion based on the second beam direction. The apparatus 1202, and in particular the baseband unit 1204, may further include means for transmitting or receiving a first transmission of the one or more channels associated with a first CORESET based on the first beam direction. The apparatus 1202, and in particular the baseband unit 1204, may further include means for transmitting or receiving a repetition of the one or more channels associated with a second CORESET based on the second beam direction. The means may be one or more of the components of the apparatus 1202 configured to perform the functions recited by the means. As described supra, the apparatus 1202 may include the TX Processor 316, the RX Processor 370, and the controller/processor 375. As such, in one configuration, the means may be the TX Processor 316, the RX Processor 370, and the controller/processor 375 configured to perform the functions recited by the means.

In some aspects of wireless communication, e.g., 5G NR, multiple transmission configuration indicator (TCI) states may be configured at a base station and a user equipment (UE). Each TCI state may be associated with a reference signal (e.g., an SSB reference signal or a channel state information reference signal (CSI-RS)). The multiple TCI states may be used to indicate channel characteristics including a spatial parameter (e.g., a beam direction). A UE may measure multiple reference signals and transmit a report (e.g., a CSI report) regarding the multiple measured reference signals related to one or multiple TRPs at a base station. Based on the CSI report, a base station may transmit an indication (e.g., for beam switching) of a transmission beam (e.g., for at least one uplink channel) or a reception beam (e.g., for at least one downlink channel). In some aspects, the base station may transmit, based on the CSI report, an indication of a set of activated TCI states for beam switching (e.g., candidate TCI states that may be indicated in downlink control information (DCI)) via a medium access control (MAC) control element (MAC-CE). A method and apparatus for implicit beam switching for a m-TRP architecture and/or implicit updating for a set of activated TCI states for an m-TRP architecture may provide the benefit of reduced signaling (e.g., no indication transmitted in DCI or a MAC-CE). Specifically, implicit beam switching without a DCI indication and implicit updating for a set of activated TCI states without a MAC-CE signaling may provide the benefit of reducing the signaling overhead.

In an aspect of the disclosure, a method, a computer-readable medium, and an apparatus are provided. The apparatus may be a device at a user equipment (UE). The device may be a processor and/or modem at a UE or the UE itself. The UE may be configured to transmit, to a base station having multiple TRPs, a CSI report based on a set of reference signals, the set of reference signals including a first reference signal associated with a first beam direction and a second reference signal associated with a second beam direction. The UE may further be configured to switch, for one or more channels, to use the first beam direction with a first TRP of the multiple TRPs based on the set of reference signals before receiving any transmission corresponding to the first beam direction from the base station.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to transmit, to a base station having multiple TRPs, a CSI report based on a set of reference signals, the set of reference signals including a first reference signal associated with a first beam direction and a second reference signal associated with a second beam direction; and switch, for one or more channels, to use the first beam direction with a first TRP of the multiple TRPs based on the set of reference signals before receiving any transmission corresponding to the first beam direction from the base station.

Aspect 2 is the apparatus of aspect 1, where the at least one processor is configured to switch to use the first beam direction with the first TRP based on the set of reference signals before receiving a DCI is received that indicates an update to a TCI state.

Aspect 3 is the apparatus of any of aspects 1 and 2, where at least one processor is configured to switch switches to use the first beam direction with the first TRP based on the set of reference signals before receiving an activation of a TCI state is received from the base station.

Aspect 4 is the apparatus of any of aspects 1 to 3, the at least one processor being further configured to switch, for the one or more channels, to use the second beam direction with a second TRP of the multiple TRPs based on the set of reference signals before receiving any transmission corresponding to the second beam direction from the base station.

Aspect 5 is the apparatus of aspect 4, where the first reference signal and the second reference signal have a QCL type D relationship with a pair of TCI states or with a single TCI state that includes a parameter to indicate multiple beams.

Aspect 6 is the apparatus of aspect 5, the at least one processor being further configured to transmit or receive a control channel, in an sDCI operation with the multiple TRPs, based on the first beam direction.

Aspect 7 is the apparatus of aspect 6, the at least one processor being further configured to transmit or receive a first transmission of the one or more channels in a first occasion based on the first beam direction and transmit or receive a repetition of the one or more channels in a second occasion based on the second beam direction.

Aspect 8 is the apparatus of aspect 7, where the first occasion and the second occasion are FDM or SDM, and the CSI report includes a group-based CSI report or a multi-beam CSI report for inter-cell TRPs.

Aspect 9 is the apparatus of aspect 7, where the first occasion and the second occasion are TDM, and the CSI report includes a non-group-based CSI report, a group-based CSI report, or a multi-beam CSI report for inter-cell TRPs.

Aspect 10 is the apparatus of any of aspects 5 to 9, where for an mDCI configuration for communication with the multiple TRPs, the at least one processor is further configured to transmit or receive a first transmission of the one or more channels associated with a first CORESET based on the first beam direction and transmit or receive a repetition of the one or more channels associated with a second CORESET based on the second beam direction.

Aspect 11 is the apparatus of aspect 10, where the first transmission and the repetition are FDM or SDM, and the CSI report includes a group-based CSI report or a multi-beam CSI report for inter-cell TRPs.

Aspect 12 is the apparatus of aspect 10, where the first transmission and the repetition are TDM, and the CSI report includes a non-group-based CSI report, a group-based CSI report, or a multi-beam CSI report for inter-cell TRPs.

Aspect 13 is the apparatus of any of aspects 1 to 12, where the CSI report is a non-group-based CSI report, and the at least one processor is configured to switch to the first beam direction for reception of at least one of a PDCCH, a TDM PDSCH, a PDCCH with repetitions configured in two search space sets of two CORESETs, an SFN PDCCH, an SFN PDSCH, a PDCCH associated with a CORESET pool index, or a PDSCH associated with the CORESET pool index.

Aspect 14 is the apparatus of aspect 13, where the at least one processor is configured to switch to the first beam direction for reception in a sDCI configuration for the multiple TRPs, where the switch to the first beam direction is based on the first reported reference signal in the non-group-based CSI report.

Aspect 15 is the apparatus of any of aspects 13 or 14, the at least one processor further configured to switch, for the one or more channels, to use the second beam direction with a second TRP of the multiple TRPs based on the set of reference signals before receiving any transmission corresponding to the second beam direction from the base station, the switch to the first beam direction and the second beam direction for reception being based on an order in which the first reference signal and the second reference signal are reported in the CSI report.

Aspect 16 is the apparatus of any of aspects 1 to 15, where the CSI report is a group-based CSI report, and the at least one processor is configured to switch to the first beam direction and the second beam direction for reception of the one or more channels based on an order in which the first reference signal and the second reference signal are reported in the CSI report, the one or more channels including at least one of an FDM PDSCH, an SDM PDSCH, a PDCCH with repetitions configured in two search space sets of two CORESETs, a PDCCH associated with a CORESET pool index, or a PDSCH associated with the CORESET pool index.

Aspect 17 is the apparatus of any of aspects 1 to 16, where the CSI report is a group-based CSI report, and the at least one processor is configured to switch to the first beam direction based on the first reference signal in a first CMR set and the second beam direction based on the second reference signal in a second CMR set for reception of the one or more channels, the one or more channels including at least one of an FDM PDSCH, an SDM PDSCH, a PDCCH with repetitions configured in two search space sets of two CORESETs, a PDCCH associated with a CORESET pool index, or a PDSCH associated with the CORESET pool index.

Aspect 18 is the apparatus of any of aspects 1 to 12, 16, or 17, where the CSI report is a multi-beam CSI report for inter-cell m-TRP, and the at least one processor is configured to switch to using the first beam direction to receive a first channel based on an association with a physical cell ID.

Aspect 19 is the apparatus of aspect 18, where the first channel is further associated with at least one of a single CORESET pool index or a set of more than one CORESET pool index.

Aspect 20 is the apparatus of any of aspects 1 to 19, further including at least one antenna and a transceiver coupled to the at least one processor.

Aspect 21 is an apparatus for wireless communication including at least one processor coupled to a memory and configured to receive, from a UE, a CSI report based on a set of reference signals, the set of reference signals including a first reference signal associated with a first beam direction and a second reference signal associated with a second beam direction; and switch, for one or more channels, to use the first beam direction with a first TRP of the multiple TRPs before transmitting an indication to switch beams to the UE.

Aspect 22 is the apparatus of aspect 21, where the at least one processor is configured to switch to use the first beam direction with the first TRP before transmitting a DCI that indicates an update to a TCI state.

Aspect 23 is the apparatus of any of aspects 21 and 22, where the at least one processor is configured to switch to use the first beam direction with the first TRP before an activation of a TCI state is transmitted to the UE.

Aspect 24 is the apparatus of any of aspects 21 to 23, the at least one processor being further configured to switch, for the one or more channels, to use the second beam direction with a second TRP of the multiple TRPs before the indication to switch the beams is transmitted to the UE.

Aspect 25 is the apparatus of aspect 24, where the first reference signal and the second reference signal have a QCL type D relationship with a pair of TCI states or with a single TCI state that includes a parameter to indicate multiple beams.

Aspect 26 is the apparatus of aspect 25, the at least one processor being further configured to transmit or receive a control channel, in an sDCI operation with the multiple TRPs, based on the first beam direction.

Aspect 27 is the apparatus of aspect 25, the at least one processor being further configured to transmit or receive a first transmission of the one or more channels in a first occasion based on the first beam direction and transmit or receive a repetition of the one or more channels in a second occasion based on the second beam direction.

Aspect 28 is the apparatus of aspect 27, where the first occasion and the second occasion are FDM or SDM, and the CSI report includes a group-based CSI report or a multi-beam CSI report for inter-cell TRPs.

Aspect 29 is the apparatus of aspect 27, where the first occasion and the second occasion are TDM, and the CSI report includes a non-group-based CSI report, a group-based CSI report, or a multi-beam CSI report for inter-cell TRPs.

Aspect 30 is the apparatus of any of aspects 25 to 29, where for an mDCI configuration for communication with the multiple TRPs, the at least one processor is further configured to transmit or receive a first transmission of the one or more channels associated with a first CORESET based on the first beam direction and transmit or receive a repetition of the one or more channels associated with a second CORESET based on the second beam direction.

Aspect 31 is the apparatus of aspect 30, where the first transmission and the repetition are FDM or SDM, and the CSI report includes a group-based CSI report or a multi-beam CSI report for inter-cell TRPs.

Aspect 32 is the apparatus of aspect 31, where the first transmission and the repetition are TDM, and the CSI report includes a non-group-based CSI report, a group-based CSI report, or a multi-beam CSI report for inter-cell TRPs.

Aspect 33 is the apparatus of any of aspects 21 to 32, where the CSI report is a non-group-based CSI report, and the at least one processor is configured to switch to the first beam direction for reception of at least one of a PDCCH, a TDM PDSCH, a PDCCH with repetitions configured in two search space sets of two CORESETs, an SFN PDCCH, an SFN PDSCH, a PDCCH associated with a CORESET pool index, or a PDSCH associated with the CORESET pool index.

Aspect 34 is the apparatus of aspect 33, where the at least one processor is configured to switch to the first beam direction for reception in a sDCI configuration for the multiple TRPs, where the switch to the first beam direction is based on the first reported reference signal in the non-group-based CSI report.

Aspect 35 is the apparatus of any of aspects 33 or 34, the at least one processor further configured to switch, for the one or more channels, to use the second beam direction with a second TRP of the multiple TRPs before the indication to switch the beams is transmitted to the UE, the switch to the first beam direction and the second beam direction for transmissions being based on an order in which the first reference signal and the second reference signal are reported in the CSI report.

Aspect 36 is the apparatus of any of aspects 21 to 35, where the CSI report is a group-based CSI report, and the at least one processor is configured to switch to the first beam direction and the second beam direction for reception of the one or more channels based on an order in which the first reference signal and the second reference signal are reported in the CSI report, the one or more channels including at least one of an FDM PDSCH, an SDM PDSCH, a PDCCH with repetitions configured in two search space sets of two CORESETs, a PDCCH associated with a CORESET pool index, or a PDSCH associated with the CORESET pool index.

Aspect 37 is the apparatus of any of aspects 21 to 36, where the CSI report is a group-based CSI report and the at least one processor is configured to switch to the first beam direction based on the first reference signal in a first CMR set and the second beam direction based on the second reference signal in a second CMR set for reception of the one or more channels, the one or more channels including at least one of an FDM PDSCH, an SDM PDSCH, a PDCCH with repetitions configured in two search space sets of two CORESETs, a PDCCH associated with a CORESET pool index, or a PDSCH associated with the CORESET pool index.

Aspect 38 is the apparatus of any of aspects 21 to 32, 36, or 37, where the CSI report is a multi-beam CSI report for inter-cell m-TRP, and the at least one processor is configured to switch to using the first beam direction to receive a first channel based on an association with a physical cell ID.

Aspect 39 is the apparatus of aspect 38, where the first channel is further associated with at least one of a single CORESET pool index or a set of more than one CORESET pool index.

Aspect 40 is the apparatus of any of aspects 21 to 39, further including at least one antenna and a transceiver coupled to the at least one processor.

Aspect 41 is a method of wireless communication for implementing any of aspects 1 to 40.

Aspect 42 is an apparatus for wireless communication including means for implementing any of aspects 1 to 40.

Aspect 43 is a computer-readable medium storing computer executable code, where the code when executed by a processor causes the processor to implement any of aspects 1 to 40.

What is claimed is:

1. An apparatus for wireless communication at a user equipment (UE), comprising:
a memory; and
at least one processor coupled to the memory and configured to:
transmit, to a base station having multiple transmission reception points (TRPs), a channel state information (CSI) report based on a set of reference signals, the set of reference signals including a first reference signal associated with a first beam direction and a second reference signal associated with a second beam direction; and
switch, for one or more channels, to use the first beam direction with a first TRP of the multiple TRPs based on the set of reference signals before receiving any transmission corresponding to the first beam direction from the base station.

2. The apparatus of claim 1, wherein the at least one processor is configured to switch to use the first beam direction with the first TRP based on the set of reference signals before receiving a downlink control information (DCI) that indicates an update to a transmission configuration indicator (TCI) state.

3. The apparatus of claim 1, wherein the at least one processor is configured to switch to use the first beam direction with the first TRP based on the set of reference signals before receiving an activation of a transmission configuration indicator (TCI) state from the base station.

4. The apparatus of claim 1, the at least one processor being further configured to:
switch, for the one or more channels, to use the second beam direction with a second TRP of the multiple TRPs based on the set of reference signals before receiving any transmission corresponding to the second beam direction from the base station.

5. The apparatus of claim 4, wherein the first reference signal and the second reference signal have a quasi co-location (QCL) type D relationship with a pair of transmission configuration indicator (TCI) states or with a single TCI state that includes a parameter to indicate multiple beams.

6. The apparatus of claim 5, the at least one processor being further configured to:
transmit or receive a control channel, in a single downlink control information (sDCI) operation with the multiple TRPs, based on the first beam direction.

7. The apparatus of claim 5, the at least one processor being further configured to:
transmit or receive a first transmission of the one or more channels in a first occasion based on the first beam direction; and
transmit or receive a repetition of the one or more channels in a second occasion based on the second beam direction.

8. The apparatus of claim 7, wherein the first occasion and the second occasion are frequency division multiplexed (FDM) or spatial division multiplexed (SDM), and the CSI report comprises a group-based CSI report or a multi-beam CSI report for inter-cell TRPs.

9. The apparatus of claim 7, wherein the first occasion and the second occasion are time division multiplexed (TDM), and the CSI report comprises a non-group-based CSI report, a group-based CSI report, or a multi-beam CSI report for inter-cell TRPs.

10. The apparatus of claim 5, wherein for a multiple downlink control information (mDCI) configuration for communication with the multiple TRPs, the at least one processor is further configured to:
transmit or receive a first transmission of the one or more channels associated with a first control resource set (CORESET) based on the first beam direction; and
transmit or receive a repetition of the one or more channels associated with a second CORESET based on the second beam direction.

11. The apparatus of claim 10, wherein the first transmission and the repetition are frequency division multiplexed (FDM) or spatial division multiplexed (SDM), and the CSI report comprises a group-based CSI report or a multi-beam CSI report for inter-cell TRPs.

12. The apparatus of claim 10, wherein the first transmission and the repetition are time division multiplexed (TDM), and the CSI report comprises a non-group-based CSI report, a group-based CSI report, or a multi-beam CSI report for inter-cell TRPs.

13. The apparatus of claim 1, wherein the CSI report is a non-group-based CSI report, and the at least one processor is configured to switch to the first beam direction for reception of at least one of a physical downlink control channel (PDCCH), a time-domain multiplexed (TDM) physical downlink shared channel (PDSCH), a PDCCH with repetitions configured in two search space sets of two control resource sets (CORESETs), a single frequency network (SFN) PDCCH, an SFN PDSCH, a PDCCH associated with a CORESET pool index, or a PDSCH associated with the CORESET pool index.

14. The apparatus of claim 13, wherein the at least one processor is configured to switch to the first beam direction for reception in a single downlink control information (sDCI) configuration for the multiple TRPs, wherein the switch to the first beam direction is based on the first reported reference signal in the non-group-based CSI report.

15. The apparatus of claim 13, the at least one processor further configured to:
switch, for the one or more channels, to use the second beam direction with a second TRP of the multiple TRPs based on the set of reference signals before receiving any transmission corresponding to the second beam direction from the base station, the switch to the first beam direction and the second beam direction for reception being based on an order in which the first reference signal and the second reference signal are reported in the CSI report.

16. The apparatus of claim 1, wherein the CSI report is a group-based CSI report, and the at least one processor is configured to switch to the first beam direction and the second beam direction for reception of the one or more channels based on an order in which the first reference signal and the second reference signal are reported in the CSI report, the one or more channels including at least one of a frequency-domain multiplexed (FDM) physical downlink shared channel (PDSCH), a spatial-domain multiplexed (SDM) PDSCH, a physical downlink control channel (PDCCH) with repetitions configured in two search space sets of two control resource sets (CORESETs), a PDCCH associated with a CORESET pool index, or a PDSCH associated with the CORESET pool index.

17. The apparatus of claim 1, wherein the CSI report is a group-based CSI report, and the at least one processor is configured to switch to the first beam direction based on the first reference signal in a first channel measurement resource (CMR) set and the second beam direction based on the second reference signal in a second CMR set for reception of the one or more channels, the one or more channels including at least one of a frequency-domain multiplexed (FDM) physical downlink shared channel (PDSCH), a spatial-domain multiplexed (SDM) PDSCH, a physical downlink control channel (PDCCH) with repetitions configured in two search space sets of two control resource sets (CORESETs), a PDCCH associated with a CORESET pool index, or a PDSCH associated with the CORESET pool index.

18. The apparatus of claim 1, wherein the CSI report is a multi-beam CSI report for inter-cell multiple transmission/reception point (m-TRP), and the at least one processor is configured to switch to using the first beam direction to receive a first channel based on an association with a physical cell ID.

19. The apparatus of claim 18, wherein the first channel is further associated with at least one of a single control resource set (CORESET) pool index or a set of more than one CORESET pool index.

20. The apparatus of claim 1, further comprising at least one antenna and a transceiver coupled to the at least one processor.

21. An apparatus for wireless communication at a base station having multiple transmission reception points (TRPs), comprising:
a memory; and
at least one processor coupled to the memory and configured to:
receive, from a user equipment (UE), a channel state information (CSI) report based on a set of reference signals, the set of reference signals including a first reference signal associated with a first beam direction and a second reference signal associated with a second beam direction; and
switch, for one or more channels, to use the first beam direction with a first TRP of the multiple TRPs before transmitting an indication to switch beams to the UE.

22. The apparatus of claim 21, wherein the at least one processor is configured to switch to use the first beam direction with the first TRP before transmitting (1) a downlink control information (DCI) that indicates an update to a transmission configuration indicator (TCI) state and before transmitting an activation of the TCI state.

23. The apparatus of claim 21, the at least one processor being further configured to:
switch, for the one or more channels, to use the second beam direction with a second TRP of the multiple TRPs before the indication to switch the beams is transmitted to the UE.

24. The apparatus of claim 23, wherein the first reference signal and the second reference signal have a quasi co-location (QCL) type D relationship with a pair of transmission configuration indicator (TCI) states or with a single TCI state that includes a parameter to indicate multiple beams.

25. The apparatus of claim 24, the at least one processor being further configured to:
transmit or receive a first transmission of the one or more channels in a first occasion based on the first beam direction; and
transmit or receive a repetition of the one or more channels in a second occasion based on the second beam direction.

26. The apparatus of claim 24, wherein for a multiple downlink control information (mDCI) configuration for communication with the multiple TRPs, the at least one processor being further configured to:
transmit or receive a first transmission of the one or more channels associated with a first control resource set (CORESET) based on the first beam direction; and
transmit or receive a repetition of the one or more channels associated with a second CORESET based on the second beam direction.

27. The apparatus of claim 21, wherein the CSI report is a non-group-based CSI report, and the at least one processor is configured to switch to the first beam direction to transmit at least one of a physical downlink control channel (PDCCH), a time-domain multiplexed (TDM) physical downlink shared channel (PDSCH), a PDCCH with repetitions configured in two search space sets of two control resource sets (CORESETs), a single frequency network (SFN) PDCCH, an SFN PDSCH, a PDCCH associated with a CORESET pool index, or a PDSCH associated with the CORESET pool index.

28. The apparatus of claim 21, further comprising at least one antenna and a transceiver coupled to the at least one processor.

29. A method of wireless communication at a user equipment (UE), the method comprising:
transmitting, to a base station having multiple transmission reception points (TRPs), a channel state information (CSI) report based on a set of reference signals, the set of reference signals including a first reference signal associated with a first beam direction and a second reference signal associated with a second beam direction; and
switching, for one or more channels, to use the first beam direction with a first TRP of the multiple TRPs based on the set of reference signals before receiving any transmission corresponding to the first beam direction from the base station.

30. A method of wireless communication at a base station having multiple transmission reception points (TRPs), the method comprising:
receiving, from a user equipment (UE), a channel state information (CSI) report based on a set of reference signals, the set of reference signals including a first reference signal associated with a first beam direction and a second reference signal associated with a second beam direction; and
switching, for one or more channels, to use the first beam direction with a first TRP of the multiple TRPs before transmitting an indication to switch beams to the UE.
